(19) United States
(12) Patent Application Publication
(10) Pub. No.: US 2003/0195765 A1
(43) Pub. Date: Oct. 16, 2003

(54) Data exchange method and system

(76) Inventors: Mukesh Sehgal, Greenwich, CT (US); Ramakant Arcot, South River, NJ (US); Rukun Duggal, New York, NY (US)

Correspondence Address: MINTZ LEVIN COHN FERRIS GLOVSKY & POPEO, 666 THIRD AVENUE, NEW YORK, NY, 10017, US

(21) Appl. No.: 10/411,580

(22) Filed: Apr. 10, 2003

Related U.S. Application Data
(60) Provisional application No. 60/371,640, filed on Apr. 10, 2002.

(51) Int. Cl. G06F 17/60

(52) U.S. Cl. 705/1

(57) ABSTRACT

Systems and methods for integrating data between disparate systems is provided which may include receiving one or more first publisher data records at a processing computer, the first publisher data records being received from a first publisher system and comprising data extracted from a first publisher database and arranged in the first publisher data records in one or more first publisher fields according to a first publisher template. One or more of the first publisher fields correspond to one or more fields of the first publisher database. The systems and methods may also include parsing all or a portion of the data from one or more of the first publisher data records into one or more corresponding first recipient data records according to a master template. The data is arranged in one or more of the first recipient data records in one or more first recipient fields according to a first recipient template. In addition, the master template includes one or more master fields for establishing a mapping between one or more first publisher fields of the first publisher data records and one or more first recipient fields of the first recipient data records.

### CLAIM TO PRIORITY

The present invention claims priority under 35 U.S.C. § 119(e) of U.S. provisional patent application No. 60/371,640, filed Apr. 10, 2002, the entire disclosure of which is herein incorporated by reference.

### FIELD OF THE PRESENT INVENTION

The present invention relates to methods and systems for integrating data, and more particularly, to a method and system which enable the exchange of data among disparate computer systems, for example, simply and easily, through a hub-and-spoke style system that permits the addition of new systems or modification of systems already connected.

### BACKGROUND OF THE PRESENT INVENTION

When Information Technology (IT) solutions became universally available, organizations started automating their business processes. However, these automation exercises were done on an ad-hoc basis within the functional units of the organization using disparate and proprietary IT solutions for their needs.

As the dependence on IT for the business processes increased, the need for the IT systems to communicate with each other also increased. However, the IT systems that businesses had in place within their enterprise did not have the capabilities to communicate with each other. The IT departments had to spend enormous amounts of time and money to integrate these systems. Exchanging data with systems outside the enterprise was even more difficult with multiple standards, formats, and system requirements. Data exchange systems, such as Electronic Data Interchange (EDI) were developed, but remained prohibitively expensive and inflexible. New methods for data exchange, such as XML (Extensible Markup Language), are still nascent. Most systems still do not properly support these technologies, and industry standards remain incomplete.

The result is that IT departments are required to create custom data bridges, or scripts, for each set of systems that need to exchange data. These scripts are often complex, and require adjustment for any system upgrade or modification—an arduous task that may disrupt the function of the system to be integrated and of any other system connected to that system.

Specifically, when faced with the problem of non-communication between disparate IT systems, others developed homegrown systems in the form of localized scripts or applications that migrated data from one system to another. Maintaining such homegrown scripts is error-prone, time-consuming and costly. The problem is aggravated when more IT homegrown systems are added to the organizational framework.

### SUMMARY OF THE PRESENT INVENTION

The present invention makes data integration between computer systems a simple and cost-effective exercise. Data may now be quickly, easily, and securely integrated between disparate IT systems both within an organization, and with IT systems of outside partners, suppliers, and customers.

Using a hub-and-spoke style model, for example, the present invention may provide a simple and cost-effective means for business process integration. In some embodiments of the present invention, an Integration system (e.g., a server) operates as a hub between a plurality of spoke systems, and integrates data from one system, for example, to a plurality of other systems, both inside and outside the enterprise. This includes, but is not limited to, connecting systems among different departments within an organization, legacy and modem systems, B2B exchanges, client systems, partner systems, vendor systems and the like.

Some embodiments of the present invention may also transmit data from one system to email applications, fax machines, pagers and other handheld communication devices, via the Integration Server, thus enabling the broadcast of information to one or more systems. In the B2B space, the present invention may replace EDI/Value Added Network (VAN) to communicate with partners and suppliers, for example.

Business transactions tend to be islands of automation linked together by manual procedures such as the re-keying of information, or the importing data from one format to the other. The present invention enables businesses to build bridges between such islands, eliminating manual entry work and its associated costs and errors, by automating the business processes. Compared with manually transferring data, or with building custom scripts, the present invention offers the following features and advantages:

Transmission of data to recipients without their needing to make any changes to their underlying data structures. One of the major drawbacks with the traditional scripting mechanisms is that when a recipient or publisher data structure is changed, considerable time and money has to be spent to revisit data exchange scripts to make the necessary changes to the coding logic.

Enabling centralization of all business processes and providing a gateway to access this data through a web portal. Another major drawback of traditional scripting is that scripts are diversified in their existence and run localized to a certain business process, making them difficult to administer and maintain.

Standardization of connections between systems. With traditional scripts, it is often difficult to revisit work that has been done by another engineer, especially, as is too often the case, if that work is not properly documented. By standardizing the integration methodology, and by presenting an easy to understand user interface (e.g., GUI), the present invention enables multiple engineers to understand, at a glance, any work that has occurred to date, and quickly modify it.

Accordingly, in a first aspect of the present invention, a method for integrating data between computer systems may be provided and may include extracting data from a first publisher database of a first publisher system to create one or more first publisher data records. The data in one or more of the first publisher data records is arranged in one or more first publisher fields according to a first publisher template and one or more of the first publisher fields correspond to one or more fields of the first publisher database. The method may also include parsing all or a portion of the data from one or more of the first publisher data records into one or more corresponding first recipient data records according to a master template. The data is arranged in one or more of the first recipient data records in one or more first recipient fields according to a first recipient data template. The master template includes one or more master fields for establishing a mapping between one or more of the first publisher fields of the first publisher data records and one or more of the first recipient fields of the first recipient data records.

In another aspect of the present invention, a method for integrating data between computer systems may include receiving one or more first publisher data records, where the first publisher data records may be received from a first publisher system and include data extracted from a first publisher database and arranged in the first publisher data records in one or more first publisher fields according to a first publisher template. The one or more first publisher fields correspond to one or more fields of the first publisher database. The method may also include parsing all or a portion of the data from one or more first publisher data records into one or more corresponding first recipient data records according to a master template. The data may be arranged in one or more of the first recipient data records in one or more first recipient fields according to a first recipient template. Moreover, the master template may include one or more master fields for establishing a mapping between one or more first publisher fields of the first publisher data records and one or more first recipient fields of the first recipient data records.

In yet another aspect of the present invention, a method for integrating data between computer systems may include receiving a plurality of sets of one or more respective publisher data records each from a respective publisher system and parsing all or a portion of the data in each set of publisher data records into one or more sets of respective recipient data records for a respective recipient system according to a master template. The data contained in each respective set of publisher records may be arranged according to a respective publisher template and the data in each respective set of recipient records may be arranged according to a respective recipient template. In addition, the master template may include one or more master fields for establishing a mapping between one or more respective publisher fields of one or more respective sets of publisher data records and one or more respective recipient fields of one or more respective sets of recipient data records.

In another aspect of the present invention, a system for integrating data between computer systems may include a processing computer system for receiving one or more first publisher data records. The one or more first publisher data records may include data extracted from a first publisher database of a first publisher system and arranged in one or more first publisher fields according to a first publisher template. The one or more first publisher fields correspond to one or more fields of the first database. The system may also include a processor for processing the data in one or more first publisher data records by parsing all or a portion of the data in one or more first publisher data records into one or more corresponding first recipient data records according to a master template. The data in the one or more first recipient data records may be arranged in one or more first recipient fields according to a first recipient template. The master template may include one or more master fields for establishing a mapping between one or more first publisher fields of the first publisher data records and one or more recipient fields of the first recipient data records.

In another aspect of the present invention, a system for integrating data between computer systems may include a client application operating on a first publisher system for extracting data from a first publisher database and arranging the extracted data into one or more first publisher data records. The data in the one or more publisher data records is arranged in one or more first publisher fields according to a first publisher template, and one or more first publisher fields correspond to one or more fields of the first database. The system may also include a processing computer in communication with the first publisher system. The processing computer may be used to receive one or more first publisher data records and operating a processing application for parsing all or a portion of the data from one or more first publisher data records into one or more corresponding first recipient records using a master template. The data in the first recipient data records may be arranged in one or more first recipient fields according to a first recipient data template. Moreover, the master template may include one or more master fields for establishing a mapping between one or more first publisher fields of the first publisher records and one or more first recipient fields of the first recipient data records. The first recipient data records may be forwarded to a first recipient system.

In another aspect of the present invention, a method for integrating data over a computer network may be provided. The computer network may allow communication between a processing computer, a plurality of publisher systems and a plurality of recipient systems in communication with the processing computer. The method may include extracting one or more sets of data from a respective database of a respective publisher system to create one or more sets of one or more respective publisher data records. The data in each set of one or more publisher data records may be arranged in one or more publisher fields according to a respective publisher template of a particular publisher system and the one or more of the respective publisher fields may correspond to one or more fields of the respective publisher database. The method may also include forwarding each set of publisher data records to the processing computer, and, using the processing computer, parsing all or a portion of the data contained in each set of publisher data records into one or more corresponding sets of one or more recipient data records according to a master template. Each set of recipient data records is for a particular recipient system and the data in each set of recipient data records may be arranged in one or more respective recipient data fields according to a respective recipient template of a particular recipient system. The master template may include one or more master fields for establishing a mapping between one or more respective publisher fields of one or more sets of publisher data records and one or more respective recipient fields of one or more sets of recipient data records. The method may further include forwarding each respective set of recipient data records to a respective recipient system.

In yet another aspect of the present invention, a system for integrating data between computer systems may include a processing system in communication with a plurality of publisher systems and in communication with a plurality of recipient systems. Each publisher system may extract one or more sets of data from a respective publisher database to create one or more sets of one or more publisher data records. In addition, the data in each set of one or more publisher data records is arranged in one or more publisher fields according to a respective publisher template of a particular publisher system. The one or more of the respective publisher fields correspond to one or more fields of the respective publisher database and each set of publisher data records are sent to the processing computer. The processing computer may parse all or a portion of each set of publisher data records into one or more corresponding sets of one or more recipient data records according to a master template, where the data in each set of recipient data records may be arranged in one or more respective recipient data fields according to a respective recipient template of a particular recipient system. The master template may include one or more master fields for establishing a mapping between one or more respective publisher data fields of one or more sets of respective publisher data records and one or more respective recipient fields of one or more sets of recipient data records.

Other aspects of the present invention may include computer readable media having computer instructions for enabling a computer system to perform one or more of the method aspects outlined above, and also may include application programs operable on a computer system for performing one or more of the method aspects outline above.

The data, in the above-embodiments, may be extracted from the first database at a predetermined time, and may for forwarded to the second system according to a predetermined protocol. Moreover, the second data records may include a second format different from a first format of the first data records.

These and other aspects, advantages, objects and features of the invention will be apparent through the detailed description of the embodiments and the drawings attached hereto. It is also to be understood that both the foregoing general description and the following detailed description are exemplary and not restrictive of the scope of the invention.

### BRIEF DESCRIPTIONS OF THE DRAWINGS

FIG. 1 illustrates an overview of the architecture of the data exchange system according to embodiments of the present invention.

FIG. 2 illustrates the relationships between a Publisher Template, a Master Template and a Recipient Template according to embodiments of the present invention.

FIGS. 3-4 illustrate representative screen shots of a graphical user interface for creating a Master Template according to embodiments of the present invention.

FIGS. 5-24 illustrate representative screen shots of a graphical user interface for creating an SQL statement and a Publisher Template according to embodiments of the present invention.

FIGS. 25-27 illustrate representative screen shots of a graphical user interface for selecting fields for a Publisher Template and mapping the selected fields to fields of a Master Template according to embodiments of the present invention.

FIGS. 28-37 illustrate representative screen shots of graphical user interfaces for creating Recipient Templates and Child Recipient Templates for embodiments of the present invention.

### DETAILED DESCRIPTION OF THE EMBODIMENTS

It is a feature of some of the embodiments of the present invention that data may be read from and written to any structured data format, among any number of systems. Accordingly, data in a first format for a first system, for example, may be read and processed into a second format for a second system. This may occur between same or different computer systems (e.g., same or different database management servers), which may be local or remote from one another. Moreover, the transmission of data between systems may be scheduled to occur on a periodic basis to keep the data on a receiving computer system current with the data on the sending system.

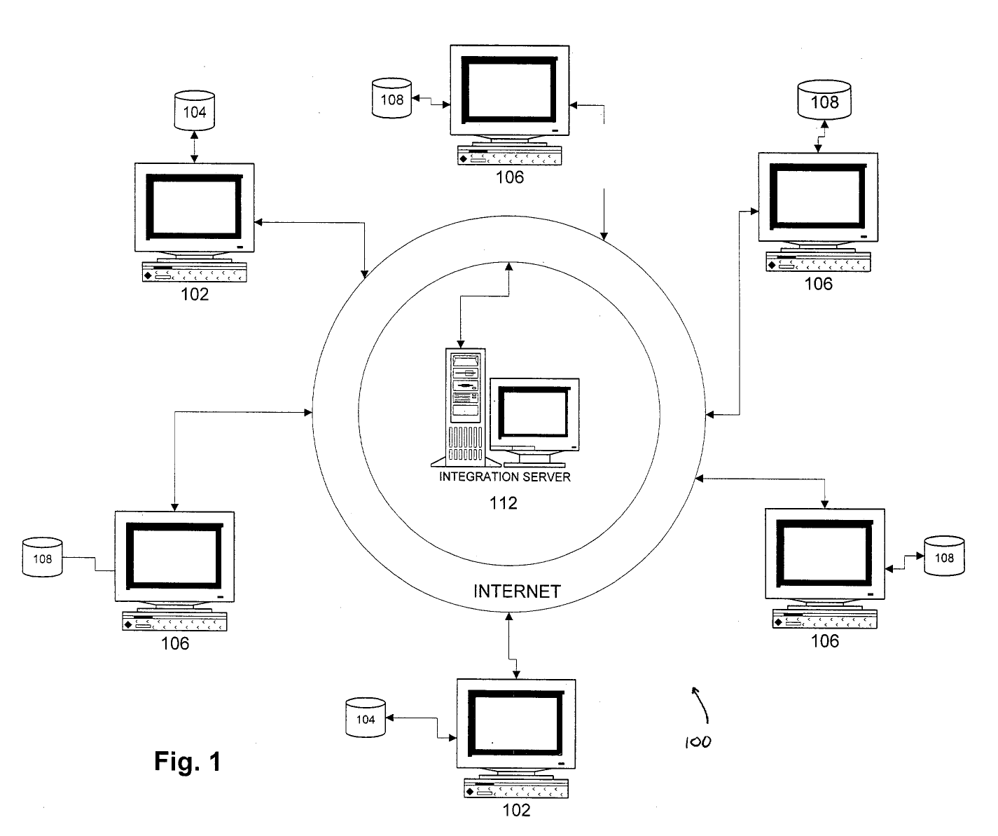

FIG. 1 illustrates an example “hub and spoke” type system for performing processes for data transmission according to some embodiments of the present invention. In these embodiments, data may be exchanged between systems over a computer network including, for example, a local-area-network (LAN), a wide-area-network (WAN) and/or the Internet. Such embodiments, thus, may be based on a client/server architecture of computer networks.

Moreover, as one of ordinary skill in the art will appreciate, devices for performing one or more of the steps of any of the processes outlined below for any of the embodiments of the present invention may be hardwired, as in the case of microprocessors, or may be performed/emulated by a computer system using software operated on one or more computer systems. Of course, such computer systems may include analog and digital hardware for operating one or more programs, which may include one or more processors, communication circuits/hardware (e.g., communication chipsets, Ethernet cards, modems, wireless communication transceivers, and the like), digital data storage devices (hard drives, CD drives), RAM, ROM, display adaptors, sound processors, input and output devices and the like. Accordingly, such hardware may be the means for operating such software (for example) to perform and emulate the steps and devices for the various embodiments discussed throughout this application.

To that end, as shown in FIG. 1, a system 100 includes at least one Publisher system 102 (e.g., a database management system such as a Microsoft® SQL Server), which may also include one or more local or remote databases 104 having data stored therein. The data may be extracted and forwarded (as Publisher data files/records) to one or more second systems 106 (having local or remote databases 108), each of which may be referred to as a Recipient system, via an Integration system (or server) 112 (e.g., Java® based network server). A Recipient system may include, for example, a database management system such as an Oracle® system, a SYBASE® system and a DB2® system, for example.

One of ordinary skill in the art will appreciate that the Integration system/server in the present invention may be any computer system that is used to exchange data between two or more other computer systems. Moreover, in some embodiments of the present invention, a single computer system may be (and/or perform the functions of) a Publisher system, an Integration system and/or a Recipient system. Thus, embodiments of the present invention may be directed to a single computer system for interchanging data between local or remote databases of single or multiple systems. To that end, single or multiple systems may represent any combination of Publisher, Integration, and Recipient systems. For example, a single system may represent a Publisher system and an Integration system, a Publisher system and a Recipient system, a Recipient system and an Integration system, or all three.

The data in a Publisher data record (containing data extracted from the Publisher system) may be arranged in data fields according to a Publisher Template. Upon the Publisher data records arriving at the Integration Server, for example, the data is parsed and/or arranged into corresponding Recipient data files/records for delivery to the Recipient system according to a Recipient Template. The Recipient data records are then sent to the Recipient system, where the data therein may be stored in one or more second databases 108 (local or remote). The Recipient data records may be of a data format different from the data format of the Publisher data records.

One of ordinary skill in the art will appreciate that the methods according to the various embodiments of the present invention may be performed using one or more client-side applications and/or server-side applications. To that end, a client-side “Adaptor” application may be resident on the Publisher (preferably) and/or Recipient systems (or other client system), and the server-side application may reside on the Integration Server, or other server, for example. Accordingly, each application, or both operating in combination, may allow a user to perform tasks which include creating, editing, deleting and administering of Master Templates, Publisher Templates and/or Recipient Templates and tasks for extracting and forwarding data from the Publisher system and for receiving data and storing it on the Recipient system, for example. In that regard, each application operating alone or in combination may also include the necessary functions for performing such tasks. Such functions may be created using a convenient graphical-user-interface (GUI) generated by the Adaptor application, for example. Interaction and operation of a server-side application program, for example, may be accomplished by a client system (e.g., Publisher and/or Recipient system) via the Internet through a web-based GUI interface such as a web-browser (e.g., Microsoft Internet Explorer®, Netscape®).

In some embodiments of the present invention, such a server-side application allows Publisher system users and Recipient system users to establish registered accounts, for example, to setup and process tasks to exchange data (and create a template, for example). The accounts include different access levels including an administrative level user and a general level user. An administrative level user preferably has administrative rights which allows the administrative user to have full access to perform administrative tasks including creating, editing, and deleting of Master Templates, Master Template formats, Publisher and/or Recipient Templates, administering of templates, and managing accounts of other users (Publisher users and/or Recipient users). Administrative level users may correspond only to Publisher systems users, since those users may be the owners of the information being requested by a Recipient system and thus, such users may desire control of the flow of information from Publisher databases. General level users may perform general level user tasks including a selection of a user status (Publisher user and/or Recipient user) and the performance of Publisher or Recipient tasks (e.g., extracting/forwarding data, administering of templates).

In some embodiments of the present invention, the creation, editing, deleting and administration of Master Templates, Recipient Templates and the performance of Recipient tasks is handled specifically through the server-side application, while the performing Publisher tasks is handled through the Adaptor application in combination with the server side application. Of course, as stated above, one of ordinary skill in the art will appreciate that the processes performed by any component of the present invention may be handled by either a server side application or a client based application (or combination thereof).

Accordingly, as stated earlier, data sent from a Publisher system is arranged according to a Publisher Template. A Publisher Template is a template of data fields each corresponding to a particular data field of one or more databases of a Publisher system, for example, and each also corresponding to a field of a Master Template. The Master Template may be a standardized collection of all the fields that may be required for exchanging data between one or more databases of the Publisher system and one or more databases of a Recipient system. The data from the Publisher system received by the Recipient system may be arranged according to a Recipient Template. A Recipient Template may be a template of data fields each corresponding to one or more databases of the Recipient system and each also to a field of the Master Template. In some embodiments of the present invention, most if not all fields in the Publisher Template and/or the Recipient Template include a corresponding matching field in the Master Template.

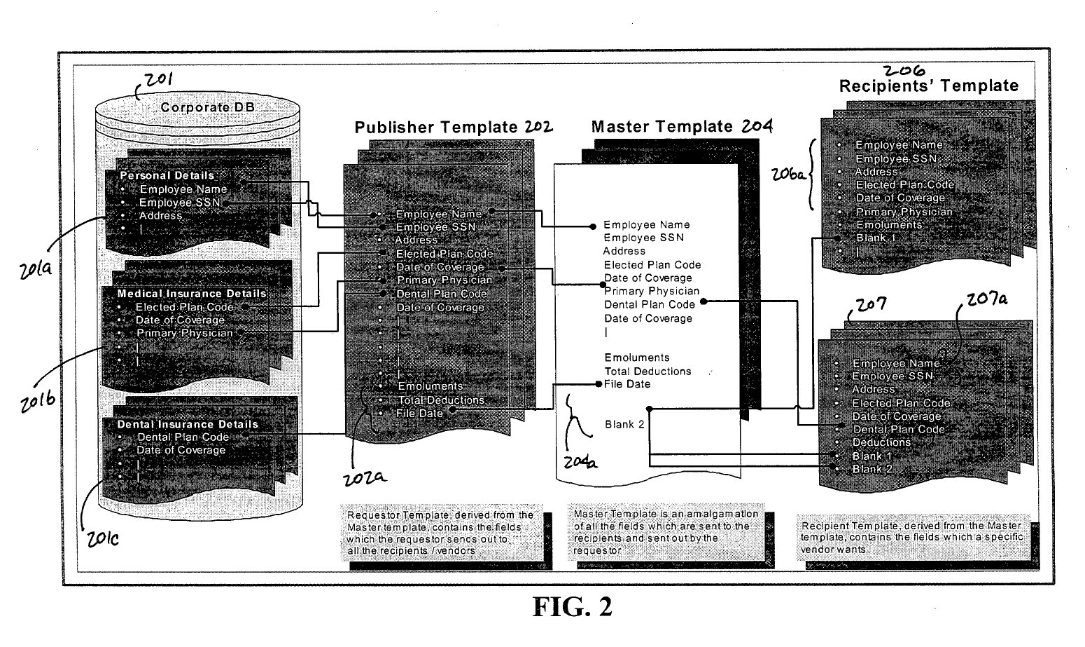

FIG. 2 illustrates an example of the relationships among the templates according to some of the embodiments of the present invention. As shown, a Publisher Template 202 includes one or more fields 202a which correspond to fields 201a, 201b and 201c of one or more databases 201 (e.g., a corporate database), for example. The fields 202a of the Publisher Template may be mapped to corresponding fields 204a in a Master Template 204. The fields 204a in the Master Template may also be mapped to one or more fields 206a of a Recipient Template 206 and fields 207a of a second Recipient Template. The fields of the Recipient Template correspond to fields of one or more databases of a Recipient system, for example.

One or ordinary skill in the art will appreciate that one or more Publisher Templates of one or more Publisher Systems may correspond to a single Master Template. The Master Template, accordingly, may also correspond to one or more Recipient Templates. Thus, multiple Publisher systems can exchange data with multiple Recipient systems using a single Master Template.

One of ordinary skill in the art will understand that mapping among fields of the Publisher Template, Master Template and Recipient Template, preferably correspond to a logical connection between the mapped fields/entities. A particular field of a Publisher Template mapped to a field of a Master Template, creates a logical connection between the two fields. In such embodiments, the mapped fields may indicate that the fields are the same field, representing the same data, for example. Thus, the data in a data record arranged according to a Publisher Template may be easily arranged in another data record arranged according to a Recipient Template using the Master Template as, for example, a “translator”.

For example, fields 201a, 201b and 201c of the corporate database 201, as shown in FIG. 2, may relate, for example, to a human resource database which includes fields 201a for personnel details of employees including, for example, employee names and corresponding social security number, address, phone and the like for each employee. Fields 201b may also include personnel data regarding medical insurance details of employees including a medical plan code, date of insurance coverage, a primary physician, and the like. Other fields 201c may include fields related to other healthcare data for employees including dental plan details such as dental plan codes and a date(s) of coverage.

The fields of a Recipient Template correspond to the fields of one or more Recipient system databases. As can be seen in this health benefits example, such data fields of the Recipient system include corresponding fields such as employee name, social security number, address, elected plan code, date of coverage, dental plan code and deductions which correspond to the corporate databases and Master Template.

In order to transfer data between two systems, a Master Template is created which preferably includes data fields for all prospective Publisher systems and Recipient systems. To that end, the Master Template is preferably created first, and the Publisher and Recipient Templates created thereafter based on the Master Template.

The fields to be included in a Master Template may be based on one or more business functions and/or rules, for example, that govern the data structures involved. In that regard, the use of separate Master Templates for data relating to different business aspects of a business is preferable. Thus, separate Master Templates may be established for databases related to any of, for example, financial information, health and benefits information, payroll information, and the like. For example, in the case of a health and benefits databases (as illustrated in FIG. 2), the Master Template may include fields that an insurance company may need to determine, for example, whether an individual may obtain health benefits, or, that a medical procedure of the insured is covered under an insurance policy.

Accordingly, when creating a Master Template, the business function of the related data is preferably selected first. Based on the selected business function, appropriate fields may then be written/selected to populate the Master Template. Such fields may be selected based on a layout in which the data is generated. In that regard, a user may need to consider the fields that may be required of one or more present and/or future Recipient systems that may ultimately receive the data from the Publisher system.

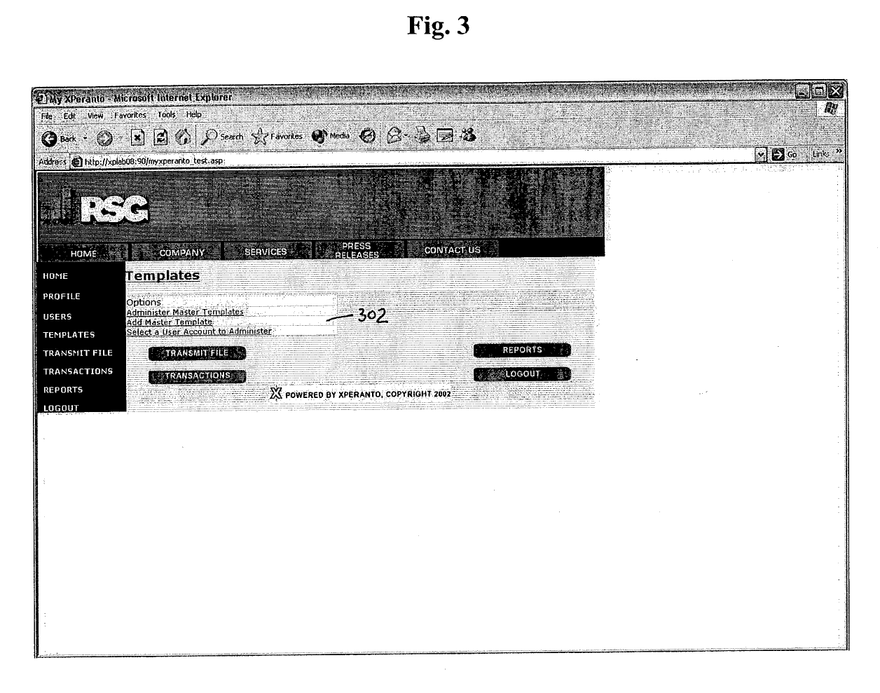

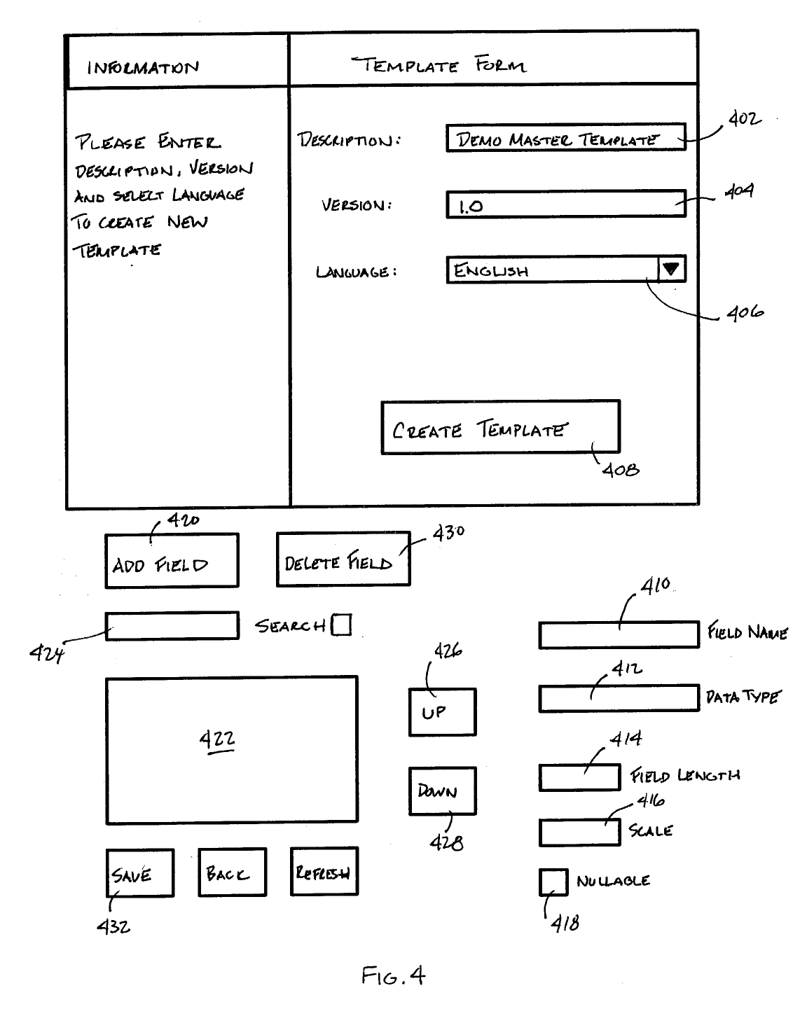

Accordingly, the task of creating the Master Template may be performed using the server-side application, for example, accessed by a client system (preferably a Publisher system) via the Internet (for example). A screenshot of an example web page for this task is illustrated in FIGS. 3 and 4. One of skill in the art will appreciate that the screenshots illustrated in the figures for the embodiments of the present invention represent only one possible arrangement of screenshots (i.e., one possible GUI), and that other arrangements may be used which may include several screens in place of one particular screen illustrated in the figures, or one screen to represent several screens.

Accordingly, when a Publisher user (preferably an Administrative user), for example, registers an account with the application, the Administrative user may start a task for creating a Master Template. As shown in FIG. 3, the Administrative user clicks on an “Add Master Template” link 302, which then displays a screen for creating the Master Template (FIG. 4). As shown in FIG. 4, a field is provided for a user to provide information for the Master Template. Such fields include a name/description field 402, a version field 404, and a drop down menu 406 for specifying a language of the Master Template. After the description information has been input to the corresponding fields, the user may click on the “Create Template” button 408, which enables the user to add fields to the Master Template using buttons and fields in the lower portion of the figures. For example, the user may enter a field name in field 410, and specify the data type of the field in data type field 412. Moreover, the user may specify a field length 414 for the field, a scale 416 for the field, as well as indicating whether the data of the field is nullable 418. For efficient operation of some of the embodiments of the present invention, field names of the Master Template are preferably a standard name for the applicable data (e.g., “employee_ssn”) so that they may be closely matched to existing databases, for example.

After the information for a field has been entered, the user may click on an “Add Field” button 420, which automatically enters the field in Master Template draft area 422. Area 422 lists the added fields. This list of fields may be searched by using search field 424, and may be scrolled through using buttons 426 and 428. Fields may also be selected by clicking on each (or selecting a plurality of fields using the mouse and CTRL and/or Shift keys of the keyboard), and deleted by using the “Delete Button” 430. Once the user has entered the desired fields, the Master Template may be saved (either on a local or remote database) using the “Save” button 432. The “Back” button 434 and “Refresh” button 436 may perform the same functions as a back button and refresh button for typically present on a web browser.

When a Master Template has been stored it may be modified from time to time, if desired. However, modification of the Master Template may require that any Publisher Templates and Recipient Templates dependent upon the Master Template be modified accordingly.

Once a Master Template has been created, tasks may be performed by Publisher users and/or Recipient users for transferring data, for example. In order to perform a task of transferring data, however, the Publisher and Recipient templates preferably must exist or be created so that a Recipient system may obtain data from a Publisher system.

With regard to a Publisher Template, one is preferably constructed so that the fields contained therein correctly and/or adequately populate the corresponding fields of the Master Template. To that end, the fields of the Publisher Template may be selected by using structured query language (SQL) as it is applied to databases from which information is sought from the Publisher system. SQL is a standard language used to search databases. Accordingly, ANSI standard SQL-3, an example of one such standard for SQL, is herein incorporated by reference.

To that end, a convenient graphical-user-interface (GUI) for forming an SQL statement for obtaining the required fields from databases for the Publisher Template may be used, which may be generated by the Adaptor and/or server-side application. The GUI may be referred to as an SQL Designer, which provides a unique method of forming the SQL statement without the necessity of manually typing in code. Specifically, users, for example, may drag-and-drop tables of one or more particular databases, link tables, select columns, add computed fields, create joins, and specify business rules for the SQL statement (for example). Such business rules may include, for example, “where” clauses, “group by” clauses, “having order by” clauses, and the like.

The SQL Designer may handle the creation of complex SQL statements using data manipulation language (DML). The use of DML enables users to create data manipulation blocks which may then be used to create the SQL statement. Externally stored procedures may also be stored and called up to create the SQL statement. For example, one may have a stored procedure that creates a temporary table and updates it with required data. This procedure may be executed prior to executing the SQL statement for inclusion therein.

Of course, some embodiments of the present invention may also allow programmers to simply type their own code for the SQL statement without using the drag-and-drop features, however, it may be less convenient. Thus, the present invention affords great flexibility in creating an SQL statement by allowing at least several different methods of creating the SQL statement.

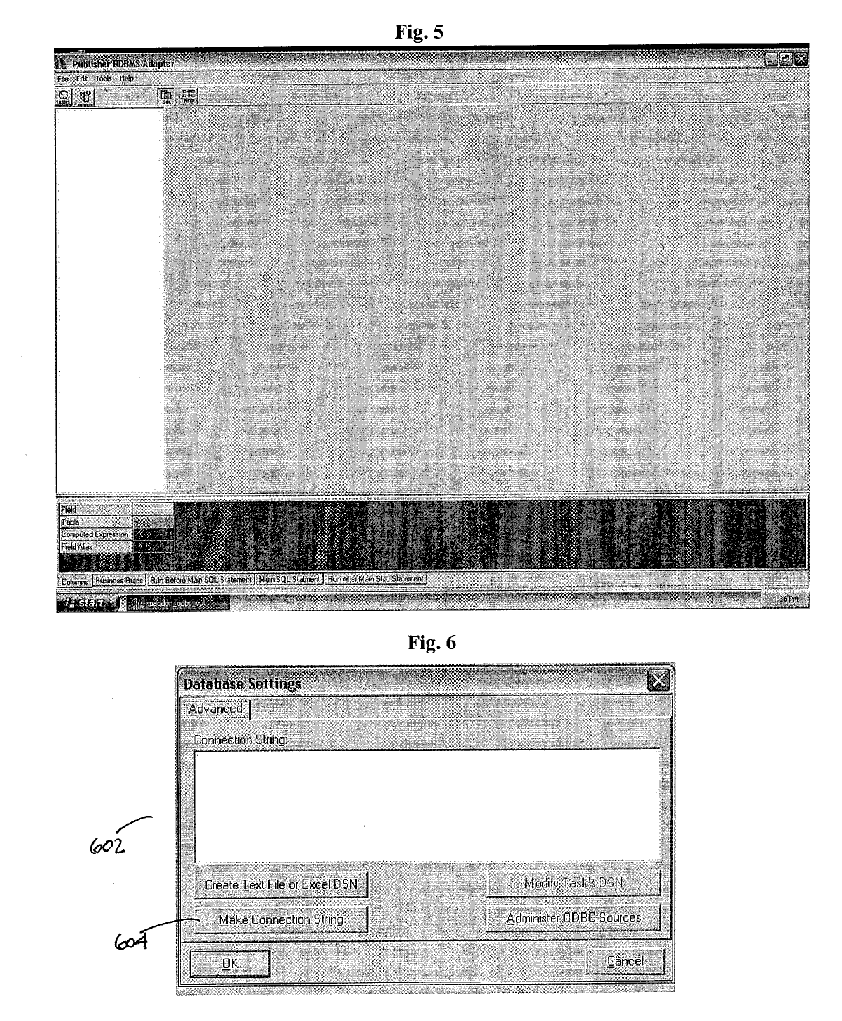

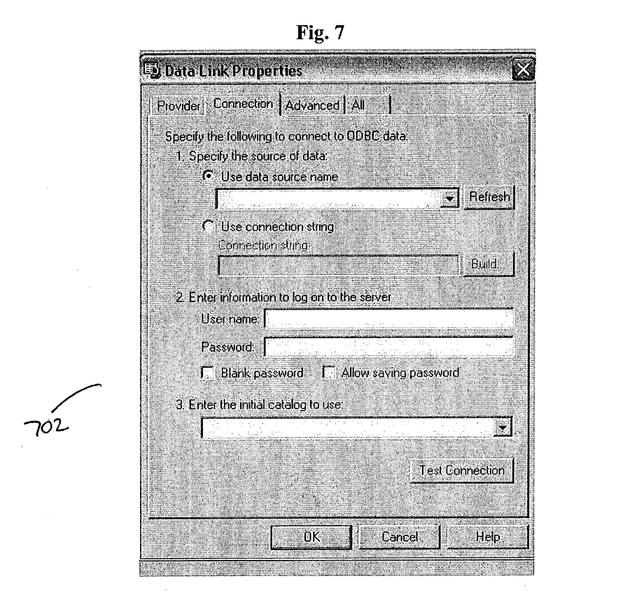

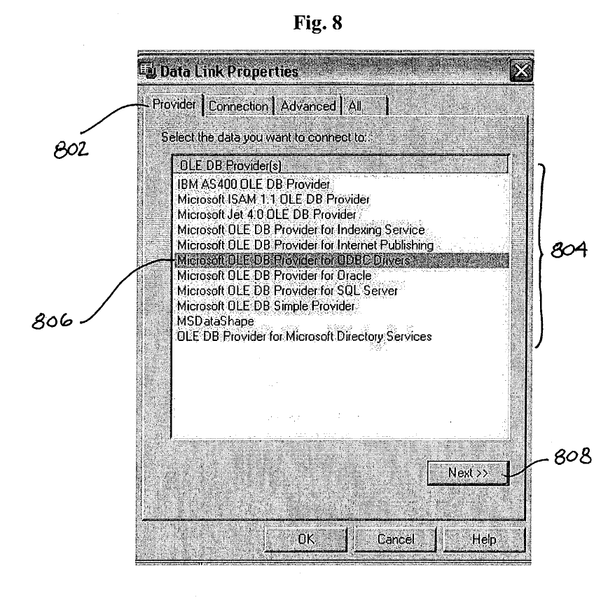

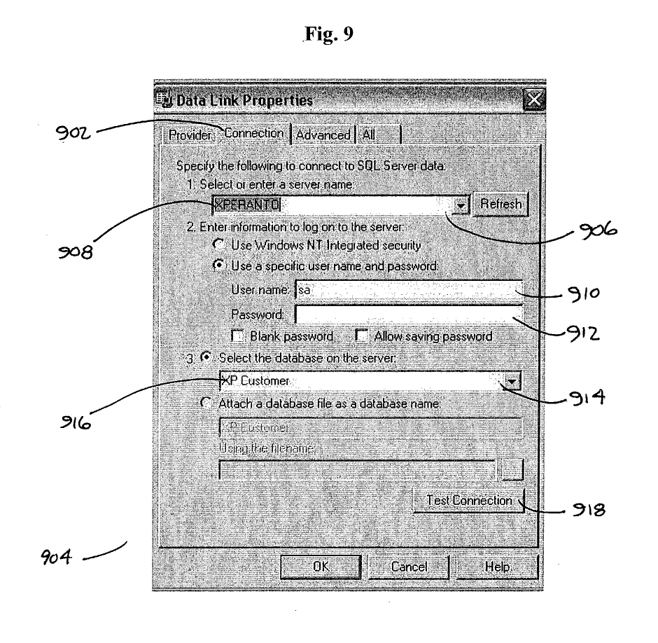

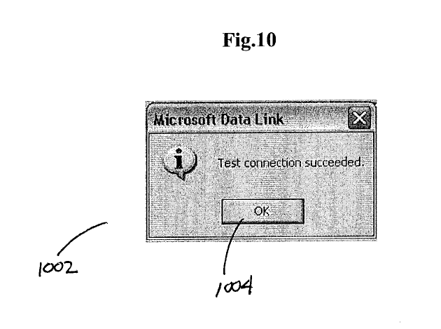

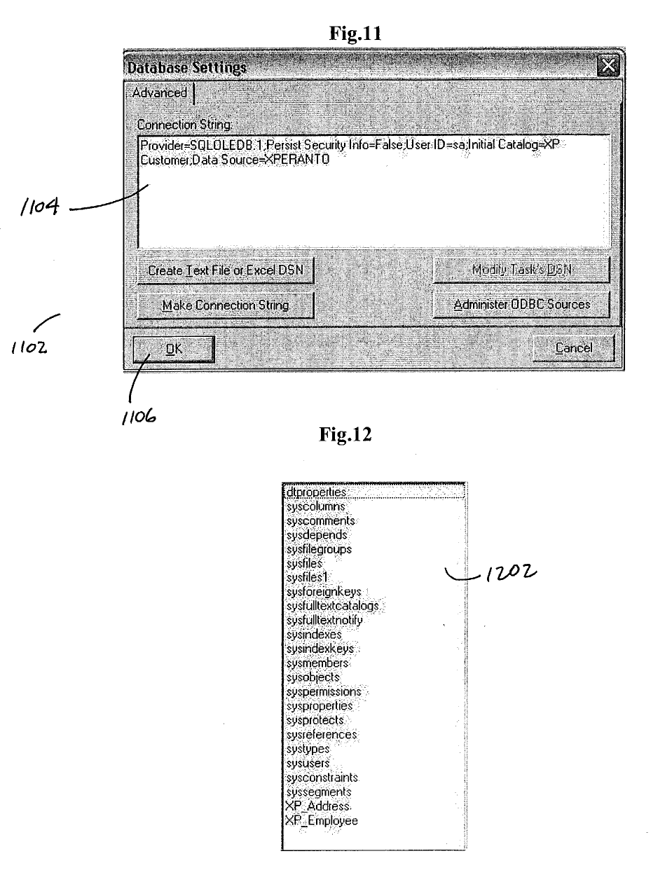

FIGS. 5-22 illustrate screenshots of an SQL Designer according to some embodiments of the present invention, which help illustrate one example process for forming a Main SQL statement to generate the necessary fields for creating the Publisher Template. Accordingly, FIG. 5 illustrates an opening screenshot of the SQL Designer from the Adaptor application (for example). To connect to a database, a user selects from the edit menu, for example, the title, “Database Settings”. A “Database Settings” box 602 is then presented (FIG. 6). Clicking on “Make Connection String” 604, displays a “Data Link Properties” box 702 (FIG. 7), where a database provider and connection parameters may be specified. By clicking on the “Provider” tab 802, a list of OLE DB providers 804 (for example) are presented (FIG. 8). In the present example, the “Microsoft OLE DB Provider for ODBC Drivers” 806 is selected. To specify a connection, the “Next” button 808 is clicked to bring the user to the Connection Tab 902 of the Data Link Properties box 904 (FIG. 9). A drop-down menu 906 lists all available sources. Upon selecting a source, for example “XPERANTO” 908, a username 910 and/or password 912 may be provided so that access to the source may be obtained (if required). The user may also select a particular database 914 of the selected source using the Data Link Properties box. In the present example, the selected database is “XP Customer” 916. Connection to the database may be tested by clicking on the button “Test Connection” 918. If the parameters are correct, a dialog box 1002 will indicate such (see FIG. 10). Clicking on “OK” 1004 directs the user back to the “Database Settings” box 1102 (FIG. 11). As shown, a connection string 1104 is now listed. Clicking on “OK” 1106 in the Database Settings box then displays the tables 1202, for example, that belong to this database (FIG. 12).

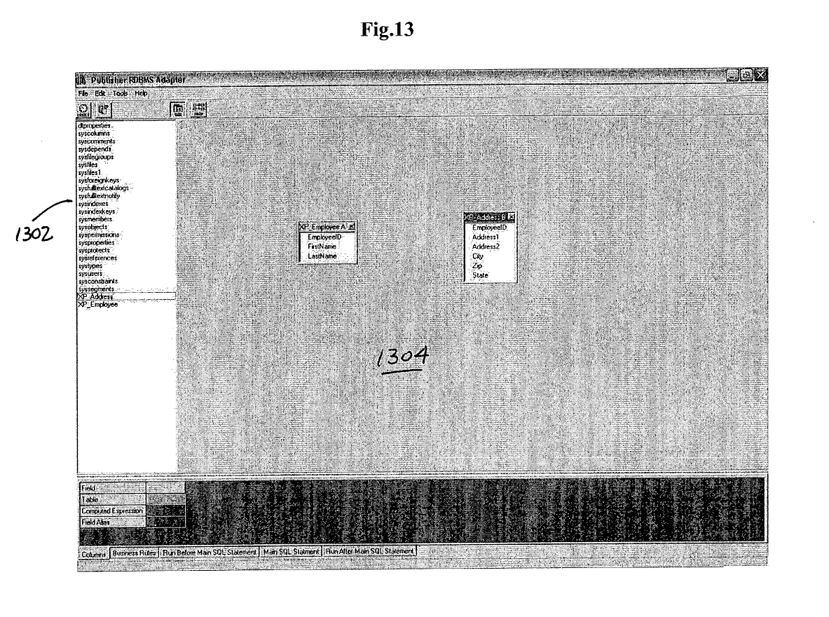

As shown in FIG. 13, the tables 1302 may be listed on the left of the screen, while a work area 1304 is provided on the right. Accordingly, tables may then be dragged and dropped from the left side of the screen into the work area to design the SQL statement. An alias for the tables may be automatically added, for example, so that a change of data source has no effect on the Publisher Template. If a data definition changes, for example, by adding or deleting a row and it forms a part of the query, then a notifier module (not shown), for example, may notify an administrator of the change so that appropriate modification may be made the Publisher Template.

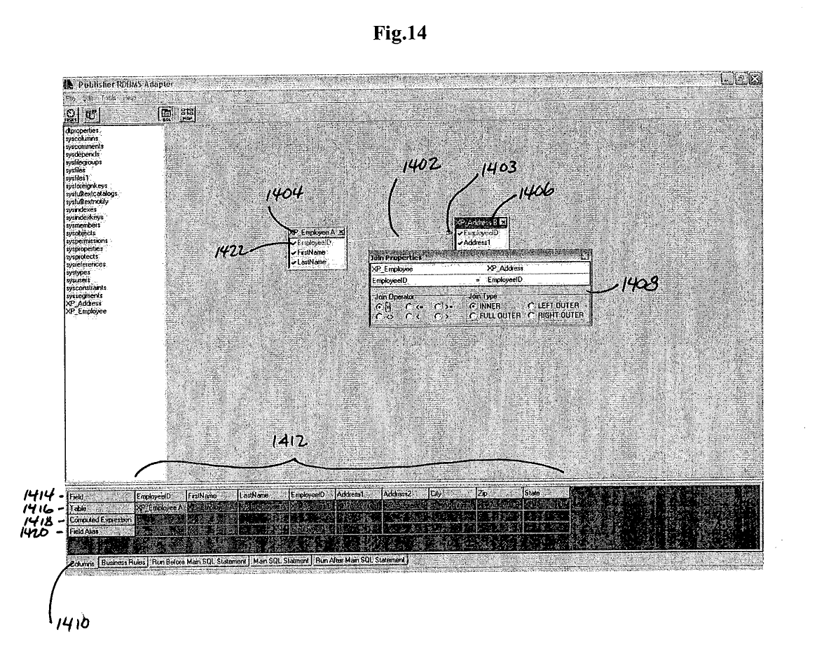

FIGS. 14-21 are screen shots illustrating the generation of a Main SQL statement, the SQL statement that will ultimately be used to find and select fields for the Publisher Template. After a user has dropped one or more tables into the work area, each may be linked and a join type specified (FIG. 14). Such a join may be graphically illustrated by a connector line 1402 between two tables 1404, 1406. The link may also be indicated using a “key” symbol 1403 for example. Right clicking on the link displays a dialog box 1408 for specifying join properties. A columns tab 1410 shows the columns 1412 that have been selected to create the data set. It may include the field name 1414, table 1416, computed expression 1418 and a field alias 1420 (if any), for example. A checkmark 1422 may be indicated next to a column title to indicate that it will be part of the query.

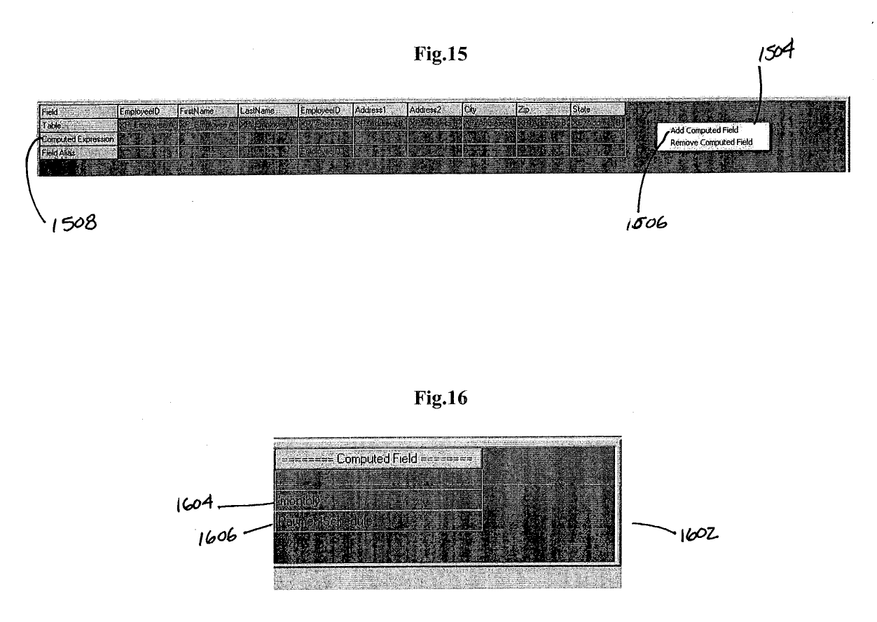

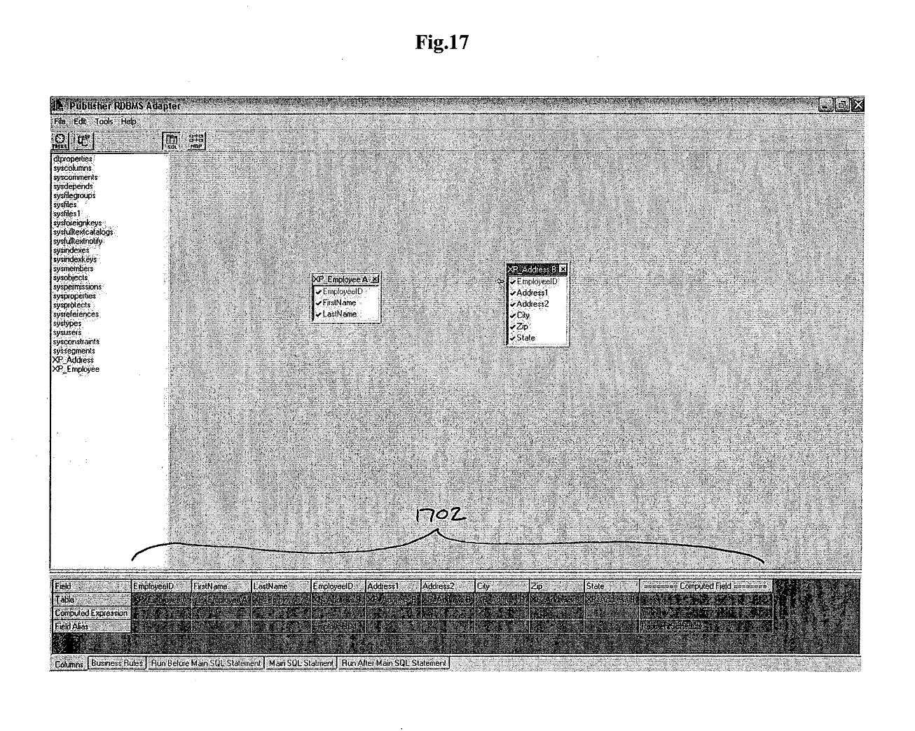

Computed fields (FIG. 15) may be added by, for example, by right clicking in the columns tab 1502 which displays box 1504 and selecting “Add Computed Field” 1506. Double clicking in the “Computed Expression” 1508 row title displays box 1602 (FIG. 16), allows the user to enter one or more an expressions 1604, 1606. An alias may be entered the same way. A completed set of columns 1702, for example, is illustrated in FIG. 17.

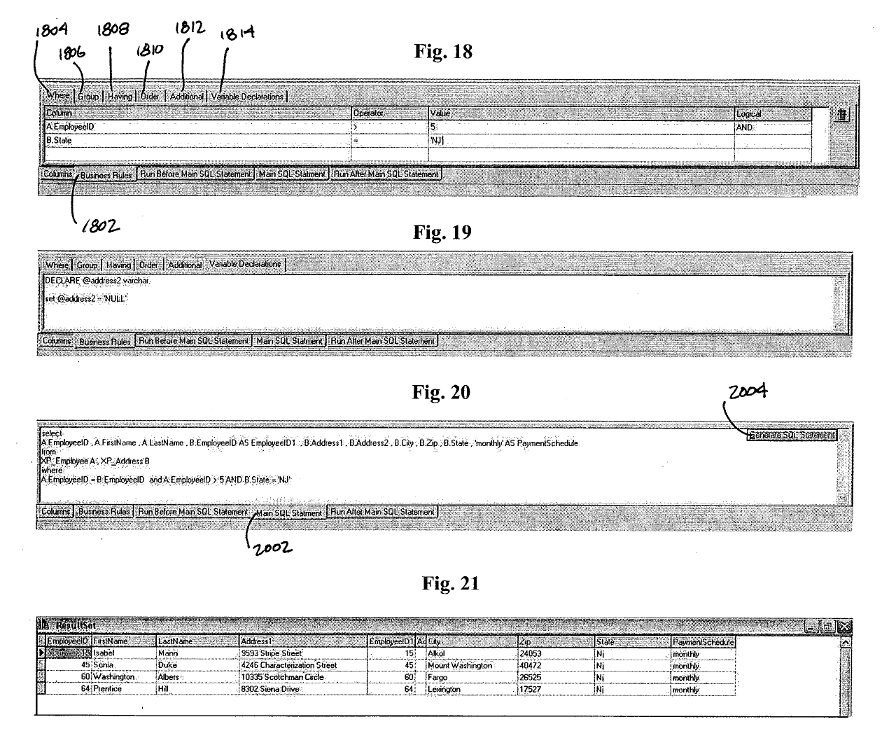

By clicking on “Business rules” tab 1802 (FIG. 18), business rules may be entered to specify the conditions for the query for the Main SQL statement. This tab may include sub-tabs for standard SQL options of specifying, for example, a “where” clause 1804, “group by” clause 1806 and a “having” clause 1808. Other sub-tabs for an “order” clause 1810, and additional clauses 1812 (e.g., distinct clauses) may be includes, as well as a tab 1814 for declaring variables (see FIG. 19). The variable declaration tab 1814 enables a user to call variables declared in any of the sub-tabs.

After all the rules have been specified, the user may go to the Main SQL statement tab 2002 (FIG. 20) and click the “generate SQL Statement” button 2204 to generate the Main SQL statement, based on the columns selected and the business rules specified. If any conditions change, the SQL statement may be regenerated by clicking the “Generate SQL” button again. A result set (FIG. 21) may then be displayed.

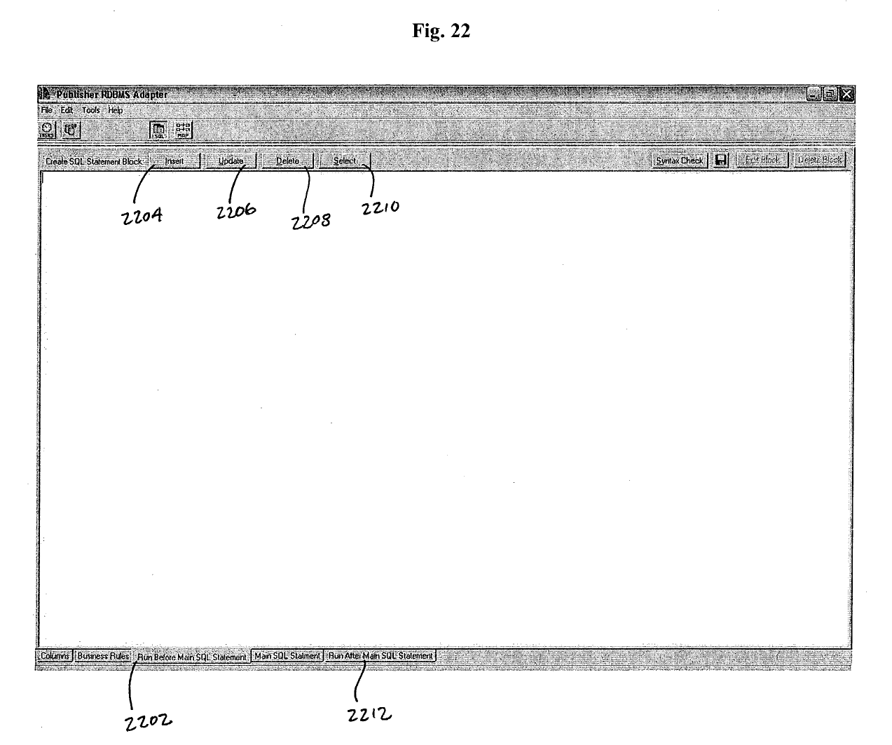

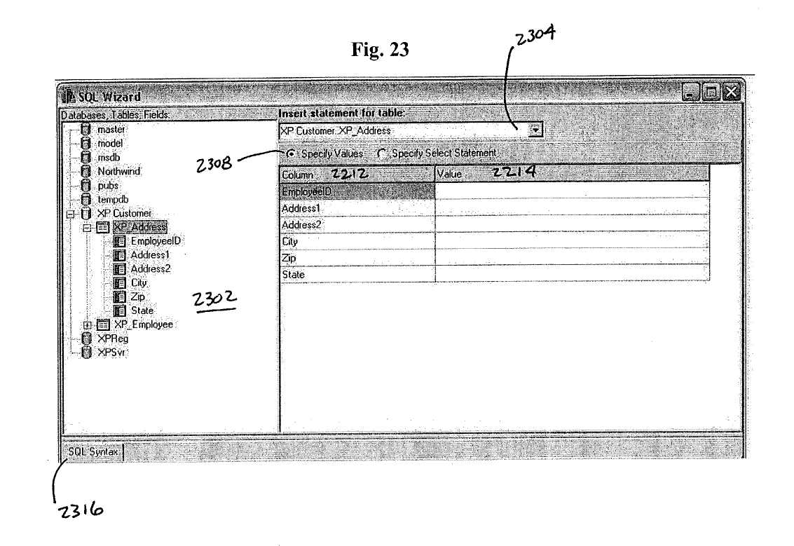

Embodiments of the present invention may include the ability to perform an SQL query which generates results to be used for generating the Main SQL statement. In that regard, a tab “Run before Main SQL Statement” 2202 (FIG. 22) is an SQL editor which creates data manipulation block for the SQL statement. These blocks may be executed prior to the execution of the Main SQL statement to produce, for example, a temporary table that the Main SQL statement may refer to. Such blocks may include: “Insert” blocks (e.g., add rows), “Update” blocks (e.g., changing data in specified columns), “Delete” blocks (e.g., remove rows) and “Select” blocks (e.g., retrieve a row). The creation of such blocks may be accomplished by clicking on the appropriate buttons 2204 (Insert), 2206 (Update), 2208 (Delete), and 2210 (Select).

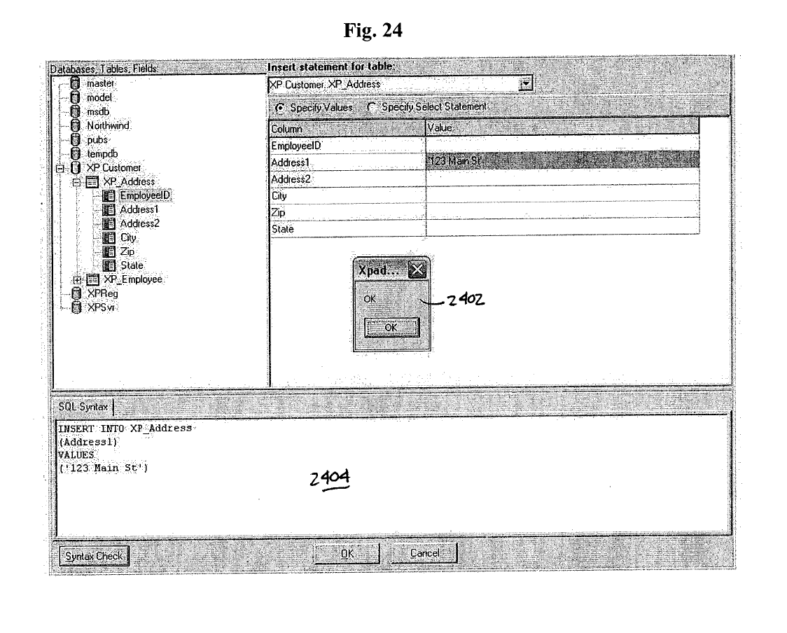

For example, clicking on the insert button 2204, displays the databases 2302 from the database source (FIG. 23). The table for which the rows are required to be inserted may be selected from the drop down menu 2304. The rows may be updated by either clicking on “Specify Values” 2308 or “Specify Select Statement” 2310. When, for example, “Specify Values” is selected, the corresponding column 2312 is displayed having an entry area 2314 for adding a value. The SQL syntax may be viewed by clicking on the “Syntax Check” button 2316. Upon the SQL syntax for the insert block being acceptable, the user may click on “OK” 2402 (FIG. 24) to create the insert block. According, the insert block 2404 is displayed. The block may then be used to generate the Main SQL statement.

A “Run After Main SQL Statement” tab 2212 (FIG. 22) may allow a user to clean up temporary tables that may be created by the “Run Before Main SQL Statement” tab. This may be especially relevant when creating Child Templates (for Publisher Templates for example) (see below). For example, a complex SQL or temporary data table for a Child Template may be created, which is then queried using simpler queries.

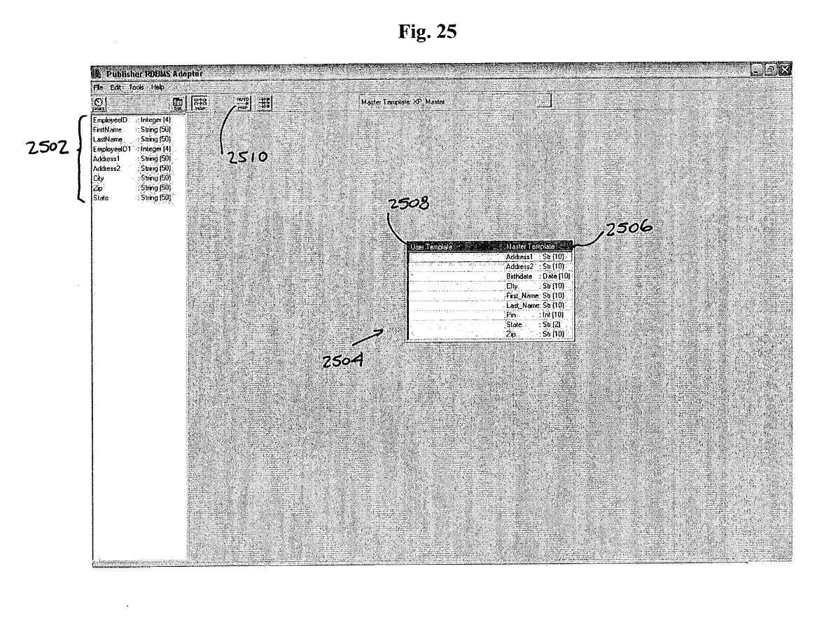

The procedures illustrated in the figures and described above produce a Main SQL statement for production of fields to create the Publisher Template. In that regard, after the Main SQL statement is created, the fields produced as a result of the Main SQL statement may be mapped to the Master Template. In one example of the present invention, as illustrated in FIGS. 25-27, the fields 2502 generated by the Main SQL statement may be displayed on a left side and a Publisher Template area 2504 may be displayed on the right side. The Publisher Template may include two columns: one column 2506 listing the Master Template fields and the other column 2508 for listing mapped fields from the SQL statement. This column may be initially blank prior to mapping.

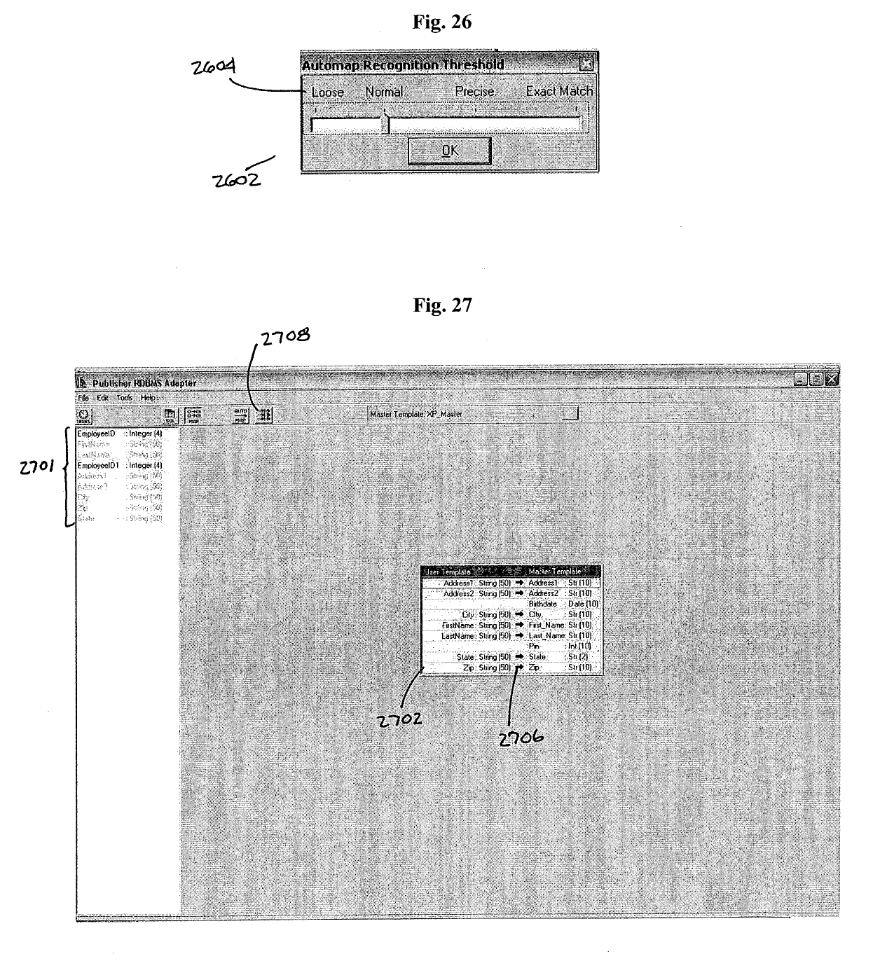

The Adaptor and/or server-side application may include an automatic mapping feature that compares the field names produced by the Main SQL Statement to the field names of selected Master Template. Accordingly, by clicking on an “Auto Map” button 2510, the process of automatic mapping be carried out. A dialogue box 2602 “Automap Recognition Threshold” (FIG. 26) may be used where the user selects a level 2604 (e.g., loose, normal precise, exact) of recognition for mapping depending on the similarity between the field names of the Main SQL statement and the Master Template. Thus, a user may have fields for the Publisher Template mapped to fields of the Master Template which exactly match the names of the fields of the Master Template, by setting the level indicator to “exact”.

After the Automapping has been carried out, the fields of the Main SQL statement 2701 (FIG. 27) that find a match according to the selected threshold level, may then be copied in the Publisher Template 2702. As illustrated, fields matched by the Main SQL statement on the left side of the screen shot and included in the Publisher Template and may be highlighted/bolded so that the user can verify which fields have been mapped. An arrow 2706 may be used, for example, to illustrate the mapping between the mapped fields. To clear a mapping, a mapped field from the Publisher Template may be dragged and dropped on the background (for example). Mapping may also be accomplished manually, for example, by dragging and dropping a field generated by the Main SQL statement into the Publisher Template and clicking a mapping button 2708.

The names of the data fields in Publisher Template may be different from the corresponding fields in the Master Template. However, preferably, the type of information in the corresponding fields is the same. For example, the data source/Publisher Template includes a field called “Fname”, and the Master Template includes a field called “First_Name”, which represents the same data. If, however, the data source/Publisher Template includes a field called “Name” that contains both the first and last names, the following may be established for the Master Template. A field in the Master Template may be added that will include both the first and last names, or, using an SQL statement, the first and last names may be split into two separate fields, to which the designer of the Publisher Template assigns to different fields for. Similarly, two or more fields from the Publisher Template may be joined to correspond to a single field in the Master Template. To that end, all the data fields in the data source/Publisher Template preferably correspond to fields available from the Master Template.

Once the Publisher Template is ready, a Recipient to whom the Publisher wishes to send data to may be selected from a list of Recipients. However, Recipients preferably must exist, and such Recipients preferably must also have previously entered at least one corresponding Recipient Template for a particular Master Template.

Recipient Templates are created via a Recipient task. Recipient tasks are tasks performed by users who desire to receive information from a Publisher system. Recipient Tasks may also include profile management and template maintenance including the administration of templates, copying/adding/deleting templates including the creation of header and trailer information, the creation of Child Templates, management of an address book and viewing of previous transactions (generating reports of transactions), for example.

Accordingly, since a Recipient Template is based on a Master Template, a Master Template is selected when creating the Recipient Template. In that regard, the creation of the Recipient Template is preferably conducted using the server side application. Thus, upon accessing the server application, and logging into a web site for the present invention, for example, a Recipient user may select a link for template maintenance. A web page for creating new Recipient Templates is presented. The creation of the Recipient Template requires the user to select an existing Master Template (or to create a Master Template).

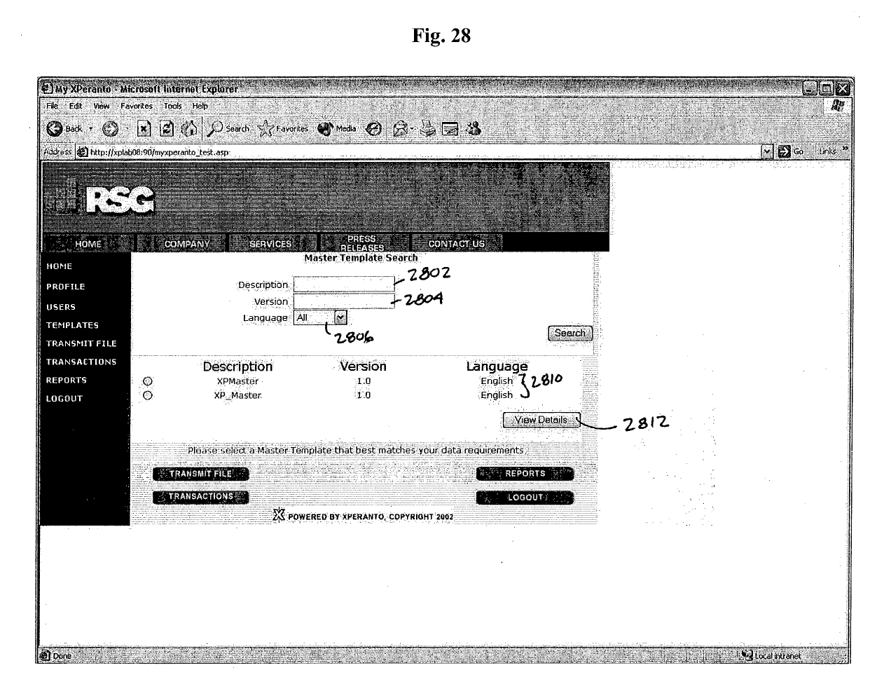

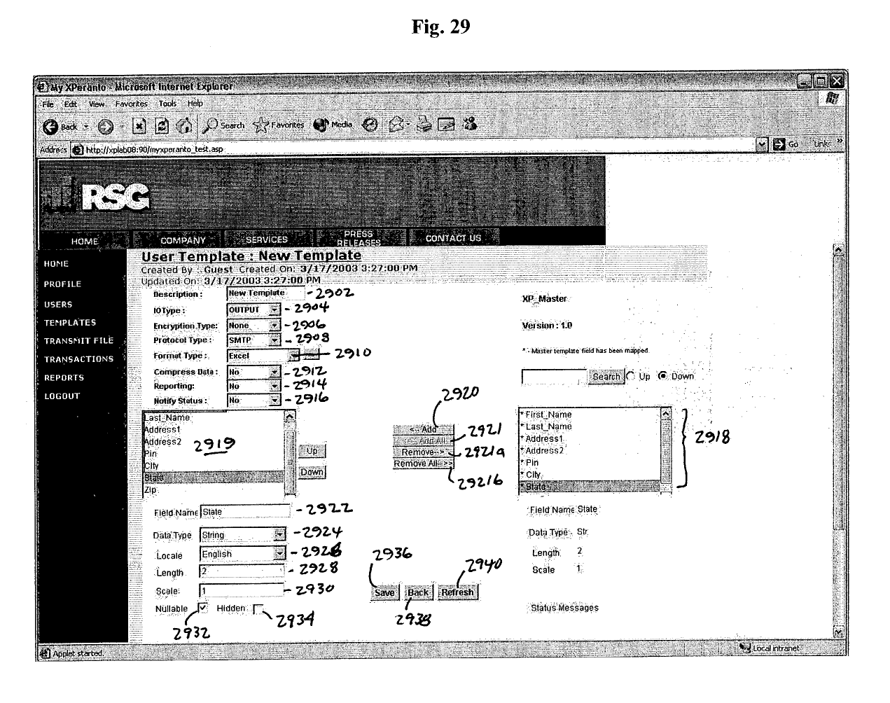

Accordingly, a Recipient preferably can search and select a particular Master Template in which the Recipient Template will be based (FIG. 28). To that end, a description 2802, version 2804 and language 2806 may be indicated, and then a search button 2808 be clicked on to query the database of Master Templates. As shown in the figure, a list 2810 of resulting Master Templates is displayed. A Master Template may be selected by double clicking on one of the found Master Templates. A single click may highlight a Master Template, upon which a user may view the details of the Master Template by then clicking on a “View Details” button 2812. According, upon selection of the Master Template, a screen for creating a Recipient Template may be displayed (FIG. 29).

The Recipient Template creation may include the following options which may be selected by the user:

Description: a name and/or description of the Recipient Template (2902)

IO Type: (2904) depending on the direction of data to and from the Integration Server, Inbound is selected if the data is sent to the Integration server (e.g., sets a computer system to a Publisher system). Outbound is selected if the data is sent from the Integration Server (i.e., a user receives data from the Integration Serve, e.g., sets a computer system to a Recipient system). For Recipient Templates, this option is selected as Outbound.

Encryption Type: (2906) the files created for forwarding to the Recipient may be encrypted before they are transmitted. For example, the Integration Server may support multiple encryption methods including PGP and Two Fish encryption. A PGP encryption module at the Integration Server, for example, may automatically encrypt the data file before transporting it. The Integration Server preferably requires two parameters to encrypt the file: and Encryption User ID and a Key ring file. The Key ring file is specific to PGP and contains the public keys that the PGP software uses for encrypting the file. Generally, a button that pops up a menu to specify these parameters may be provided in the Template.

Protocol Type: (2908) the Integration Server may support multiple methods for transmitting the data including fax, SMTP (email), HTTP (Hyper Text Transfer Protocol), FTP and Paging. To transmit the file, the Integration Server uses the details of the Fax number, email ID, paging and FTP (or the like) from the User's profile. Therefore, it is preferable that these details of the Recipient are kept current and correct.

Data Format Type: (2910) based on the layout of data in the Recipient Template, the files may be generated in different formats including Flat, CSV, XML, Binary Separated and Tab Separated file formats. A file name for this particular data may also be specified.

Compression: (2912) may be used when transmitting very large files and may include password protection.

Reporting: (2914) whether the user wishes to be notified of data received using the template (for example). Reporting may be accomplished via fax, email, voicemail, and the like. This may be selected using the field “Notify Status” 2916.

Mapping between the Master Template and the Recipient Template is automatically established when the fields 2918 from the Master Template data window are selected and added to the Recipient Template data window 2919. Accordingly, a “basket of fields” in the Master Template is made available to select appropriate fields for the Recipient Template. The Master Template fields may be joined, split, and/or otherwise manipulated when represented in the Recipient Template. The user may select a field from the Master Template Data Window and click an “Add” button 2820 (as well as “Add All” button 2821), or drag-and-drop the field from the Master Template to the Recipient Template. Similarly, fields added may be removed (“Remove” button 2821a, “Remove all” button 2821b). In addition, a user may search 2817 the fields of the Master Template to find a particular named field.

The field names of the Recipient Template may be changed in the mapping (and still correspond thereto), simply by typing in a different field name in field 2922. Moreover, the properties of the fields in the Recipient Template may be edited: the data type 2924, language 2926, field length 2928 (not more than the corresponding field length in the Master Template) and scale 2930 may be changed, as well as the data field made nullable 2932 and/or hidden 2934. After all the desired fields have been selected, the Recipient Template may be saved using “Save” button 2936. “Back” button 2938 and “Refresh” button 2940 may relate to the standard back and refresh buttons of a web-browser.

For flat file data formats sent to the Recipient system, the Integration Server may support the creation of headers and trailers, which typically are a business requirement in electronic data transfer. The header is generally the first record in the flat file. Captions or system fields may be included in the header. The Caption field may be used for entering static or text data that does not change very often and is not in the database. Examples of such fields include File Version, Comments, and Generic Information. System fields are used to display dynamic data or data that is displayed from the database. These preferred fields may be dynamically populated from the database and as such the information in them is usually current.

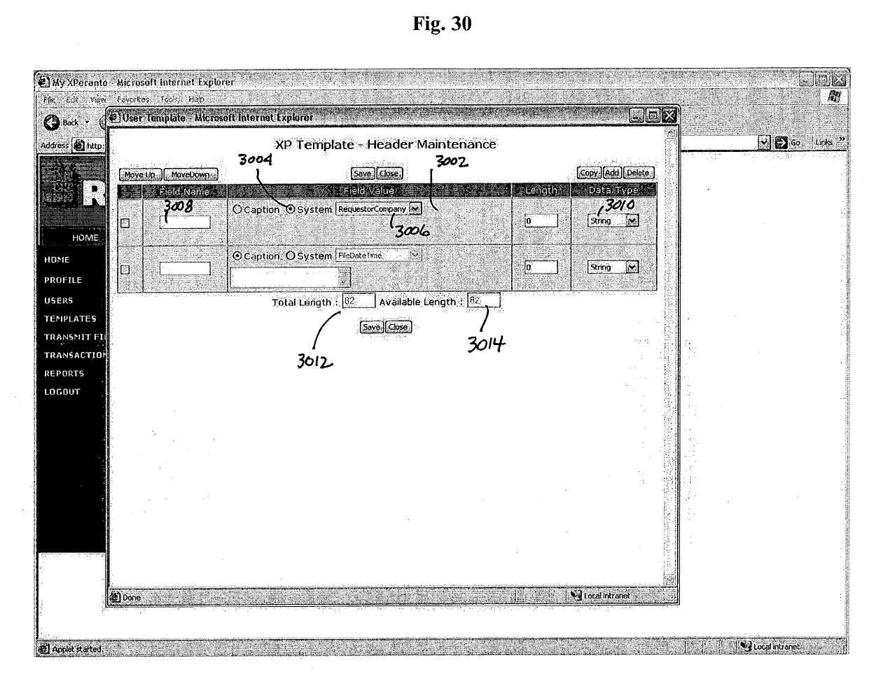

FIG. 30 illustrates a screenshot of GUI for creating header information. Accordingly, the header may include a system field 3002, so indicated by the selection of the radio button 3004. The System Fields may be made available as drop down menus 3006, and include information such as file name, file date, Publisher company, file count, month begin date, month end date, Recipient company, week begin, or week end, for example.

A user may also select the data type 3010 of the header fields from a drop-down list. All major data types may be supported. One of ordinary skill in the art will appreciate that if the selected data type is a string or numeric/integer, then a padding and/or alignment definition is preferably taken from the Recipient Template.

The header may also display both the total length 3012 and the available length 3014 of the fields. The total length gives the current length of the combined lengths of all the fields in the header. Available length is the difference between the total length of all the fields in the Recipient Template and the current total header length. The layout of the header may be changed by selecting it and clicking the move up and move down buttons.

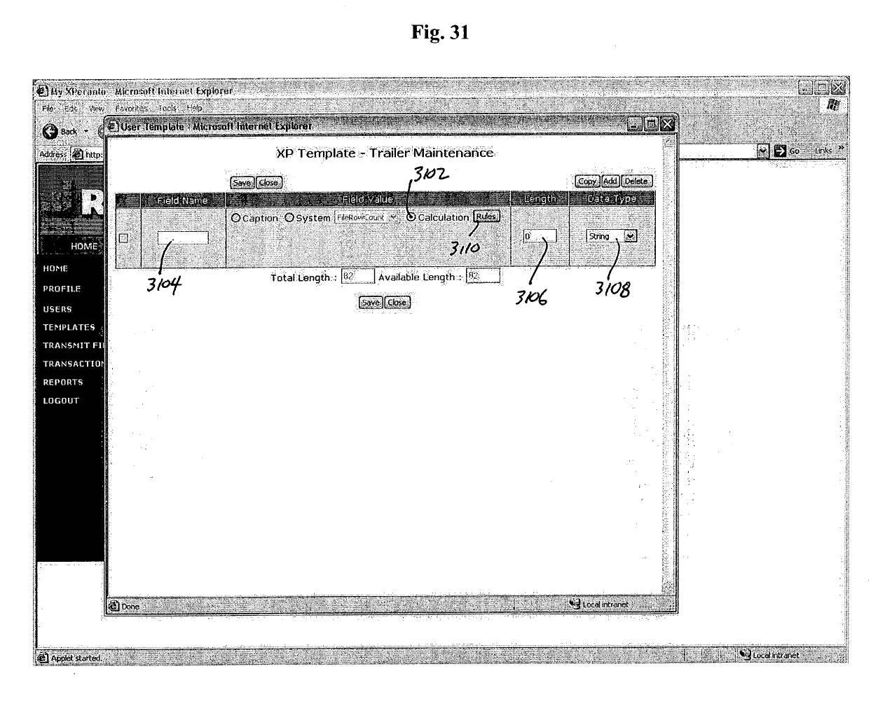

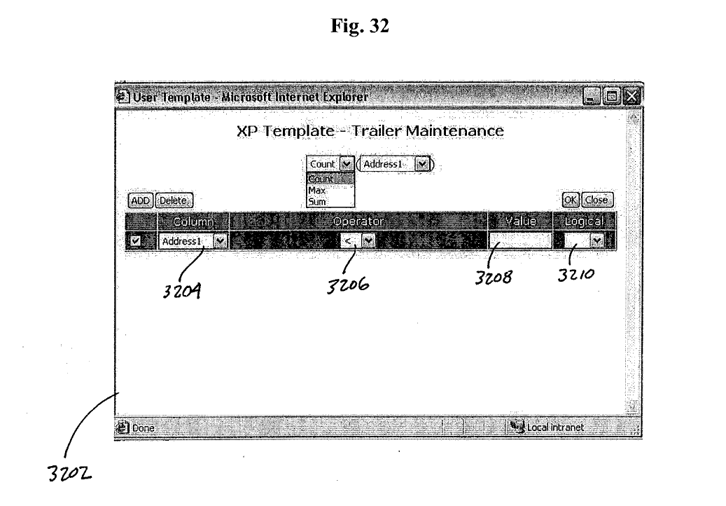

A trailer is the last record in a flat file and generally works similarly to the header. FIG. 31 illustrates a screenshot of a Trailer Maintenance GUI which is similar to FIG. 30. The Trailer may have advanced functionality to do calculations (e.g., on database fields) on flagged data. For example, to calculate the number of dependents which are equal to the sum of children and spouses, dependent records are flagged for calculation purposes.

As shown in FIG. 31, a “Calculation” radio button 3102 may be selected to specify a Trailer. Accordingly, a field name 3104 may be assigned to the Trailer, as well as the length of the field 3106 and the data type 3108 of the trailer. Using rules, calculations may then be performed. Rules may be specified using the “Rules” button 3110, which displays a dialog box 3202, where rules may be assigned to a column 3204, including adding an operator 3206, value 3208 and a logical operator 3210.

A Child (Recipient) Template may be created by a Recipient (or Publisher) and may be used to create child records, which may be written in the file sent to the Recipient system with a parent record, but with a different layout then the parent record (i.e., nested data structure). The Child Template binds with the parent Template (Publisher and/or Recipient Template) based on a binding variable. Preferably, a Child Template record may be written in the file with the parent Template, pursuant to their own layout specified while defining the parent Template. A parent Template may include multiple Child Templates.

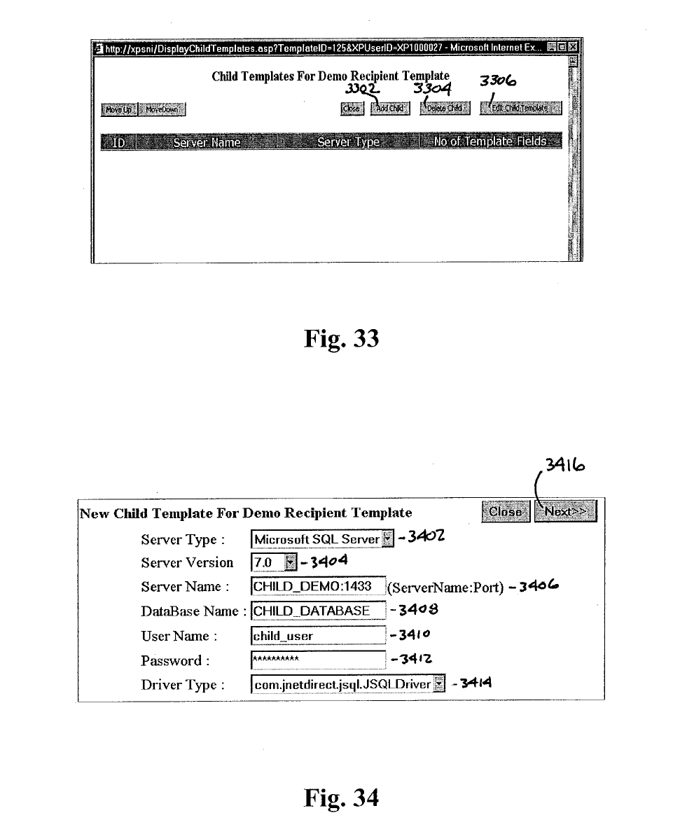

Accordingly, FIGS. 33-37 illustrate screenshots of a GUI for creating a Child Template. Access to these screens may occur by selecting an “Add Child Template” in a screen of the server-side application. As shown in FIG. 33, to add a Child Template, the user selects “Add Child” button 3302. The user may also delete 3304 or edit 3306 an existing Child Template.

By selecting “Add Child Template”, the screen illustrated in FIG. 34 is presented. This is a form for the database connection properties. Thus, a user may choose the server type 3402, server version 3404, server name 3406, database name 3408, a user name 3410 and password 3412 for accessing the database, and a driver type 3414. Clicking on “NEXT” 3416, directs the user to a screen for generating an SQL for the Child Template.

FIG. 35 illustrates a GUI for creating the Child Template. As shown, an SQL statement area 3502 is provided, as is a “where” clause area 3504. Tables and/or views are displayed in area 3506, which may be selected, added 3508 or inserted 3510 into work area 3512. Once the tables and views have been selected, the SQL statement may be generated using the “Generate SQL Statement” button 3514. The statement may be changed either through changing the selected tables and views, or by manually typing code in the SQL statement area. Manually entered text may be distinguished from the GUI generated text using, for example, a different font color.

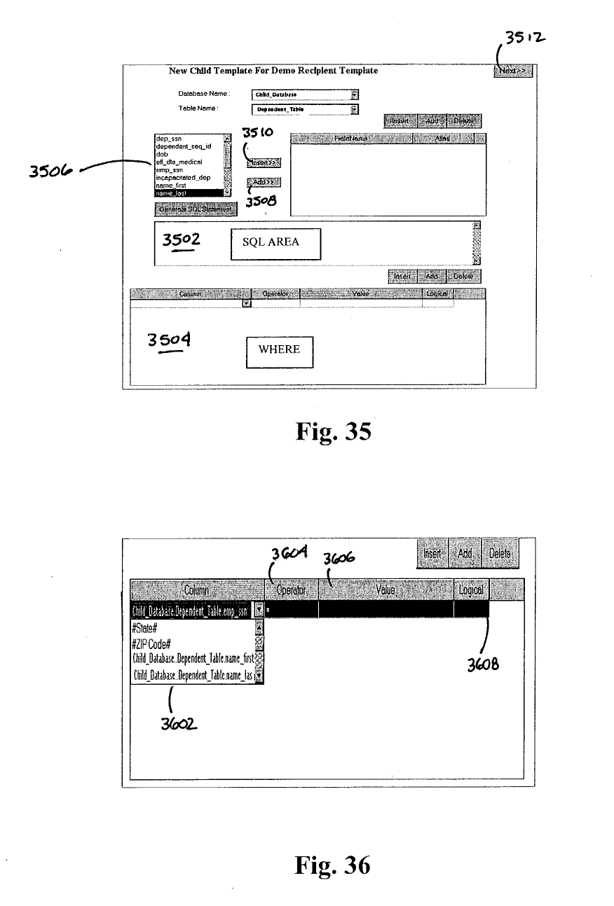

Data in the columns in the where clause area can be selected via a drop down menu 3602 (FIG. 36). Accordingly, the column includes a list of the fields of the parent Template and a list of the fields of the table selected. The fields of the parent Template may be within symbols such as “#” or “$”, depending upon the data type, for example. The operator 3604 includes a list of operators (operator may also be manually input, for example). A value column 3606 preferably includes a list of the fields of the parent Template and the selected table. A logical condition may also be included (e.g., AND, OR) 3608.

To create a binding between a Child Template and parent templates, a column in the table is preferably equal to a parent field in the Value column. For example, a table “Child_Database.Dependent_Table.emp_ssn”, may include a field “emp_ssn” (employee social security no.) to be equal to the “emp_ssn” in the parent Template.

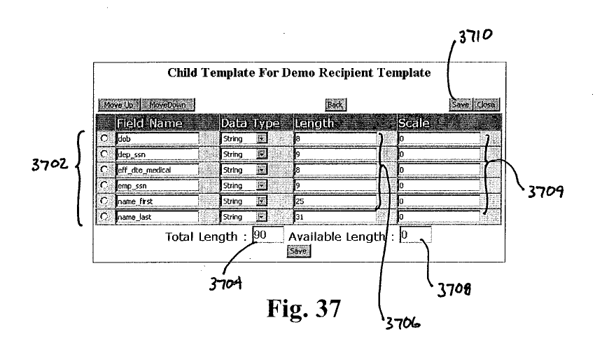

Once the SQL for the Child Template is satisfactory, the user clicks on the “NEXT” button, 3512, which displays the screen illustrated in FIG. 37, which displays the fields 3702 produced as a result of the SQL statement. The length 3702 of the fields may be adjusted in accordance with the “Total Length” 3704. Accordingly, as a user adjusts the various field lengths 3706, the “Available Length” 3708 is adjusted accordingly. The scale 3709 of each field may also be modified. After the user has created the Chile Template, it may be saved (save button 3710).

After the Publisher and Recipient Templates have been created, tasks for extracting and forwarding data from the Publisher system to the Recipient system may be performed. For example, a Publisher task for extracting and forwarding data to a Recipient system may be performed in the following manner. This example assumes that one or more Master Templates have already been created and that one or more Recipient Templates for each Master Template have also been created. Preferably, every task is based on a Master Template, thus, the user selects a particular Master Template for the task. If the Publisher user has not already created a Publisher Template, then one must be created according to the process previously outlined above, for example, for creating a Publisher Template. If a Publisher Template already exists, one or more Recipient users/systems for receiving the data is selected from a list of available Recipients. A GUI for searching a Recipient database may be used to accomplish this task.

Options for the Integration Server and how it processes the data received from the Publisher system may then be selected. Options include encrypting a stored copy (or the data itself) of the data at the Integration server (or other storage area), an option for transferring the data to the Recipient system in real time or scheduling the data for delivery at a later time, options for recurring data extraction (from the Publisher system) and delivery of the data to the Recipient system and an option for sending a notification (e.g., email, fax, voicemail) to the Publisher user should any errors occur during the forwarding of data to the Recipient system. The notification may also be set to notify a Publisher that a task was successful (e.g., that data was sent and/or received by the Publisher/Integration server).

If the Publisher user selected the option of processing the data in real time, then the task is executed after the user had finished entering the options stated above. Otherwise, the task is performed at the designated scheduled time. When the task is performed, data from the databases selected in the Publisher Template is extracted therefrom and arranged in a plurality of Publisher data files/records. The data in the Publisher data records is arranged according to the fields in the Publisher Template. The Publisher data records are then forwarded to the Integration Server.

At the Integration Server, the received Publisher records are parsed and/or arranged into Recipient files/records. The Recipient records are formed according to the particular Recipient Template. That is, each Recipient record preferably includes fields which correspond to the fields in the Recipient Template, and are formed according to the options selected for the template. That is, the Recipient records may be encrypted, compressed, and be stored in a particular format (e.g., flat, CSV, XML, binary separated, tab separated, and the like). The Recipient records may then be forwarded to the Recipient system according to the particular protocol (mode of transmission) selected according to the Recipient Template (e.g., FTP).

The present invention thus may allow one or more Publisher systems to exchange data with one or more Recipient systems using a single Master Template. For example, company A includes three subsidiaries, each having their own separate and disparate database for employee benefits. The company also uses two healthcare insurance providers. Thus, using an embodiment of the present invention, the company will establish a Master Template for health benefits (for example) for the subsidiaries to exchange data with the healthcare providers. Accordingly, each healthcare provider creates a Recipient Template and each subsidiary creates a Publisher Template. Upon each subsidiary scheduling a task of forwarding data to a healthcare provider, each subsidiary selects one or both Recipient healthcare providers to send data to, data is extracted once (for example) from each subsidiary and arranged according to the respective subsidiary's Publisher Template. The extracted data is then forwarded to the Integration Server. At the Integration Server, the received data is parsed and arranged into two separate set of data records: one set according to the Recipient Template of the first healthcare provider, and the other set according to the Recipient Template of the second healthcare provider. This is done using the mapping established by the Master Template. Each set of data records is then forwarded to the respective healthcare provider.

Accordingly, using the above systems and processes allows one to interchange data between any number of systems. Having now described some of the embodiments of the invention, it should be apparent to those skilled in the art that the foregoing is merely illustrative and not limiting, having been presented by way of example only. Numerous modifications and other embodiments are within the scope of ordinary skill in the art and are contemplated as falling within the scope of the invention as defined by the appended claims and equivalents thereto. The contents of any references cited throughout this application are hereby incorporated by reference. The appropriate components, processes, and methods of those documents may be selected for the present invention and embodiments thereof.

What is claimed is:

1. A method for integrating data between computer systems comprising:
extracting data from a first publisher database of a first publisher system to create one or more first publisher data records, wherein data in one or more of the first publisher data records is arranged in one or more first publisher fields according to a first publisher template, wherein one or more of the first publisher fields correspond to one or more fields of the first publisher database; and
parsing all or a portion of the data from one or more of the first publisher data records into one or more corresponding first recipient data records according to a master template, wherein data is arranged in one or more of the first recipient data records in one or more first recipient fields according to a first recipient data template, and wherein the master template includes one or more master fields for establishing a mapping between one or more first publisher fields of the first publisher data records and one or more first recipient fields of the first recipient data records.

2. The method according to claim 1, wherein one or more first recipient data records are stored in a first recipient database.

3. The method according to claim 1, further comprising parsing all or a portion of the data from one or more first publisher records into one or more corresponding second recipient data records according to the master template, wherein data is arranged in one or more of the second recipient data records in one or more second recipient fields according to a second recipient template, and wherein one or more master fields establish a mapping between one or more first publisher fields of the first publisher data records and one or more second recipient fields of the second recipient data records.

4. The method according to claim 3, wherein the first recipient data records are designated for a first recipient system and wherein the second recipient data records are designated for a second recipient system.

5. The method according to claim 1, further comprising:
extracting data from a second publisher database of a second publisher system to create one or more second publisher data records, wherein data in one or more second publisher data records is arranged in one or more second publisher fields according to a second publisher template, and wherein one or more second publisher fields correspond to one or more fields of the second publisher database; and
parsing all or a portion of the data from one or more second publisher data records into one or more corresponding first recipient data records according to the master template, the data being arranged in one or more of the first recipient data records in one or more first recipient fields according to the first recipient data template and wherein one or more of the master fields establish a mapping between one or more second publisher fields of the second publisher data records and one or more first recipient fields of the first recipient data records.

6. The method according to claim 5, further comprising parsing all or a portion of the data from one or more second publisher data records into one or more corresponding second recipient data records according to the master template, wherein the data being arranged in one or more of the second recipient data records in one or more second recipient fields according to the second recipient template, and wherein one or more of the master fields establishes a mapping between one or more second publisher fields of the second publisher records and one or more second recipient fields of the second recipient data records.

7. A method for integrating data between computer systems comprising:
receiving one or more first publisher data records, the first publisher data records being received from a first publisher system and comprising data extracted from a first publisher database and arranged in the first publisher data records in one or more first publisher fields according to a first publisher template, wherein one or more first publisher fields correspond to one or more fields of the first publisher database; and
parsing all or a portion of the data from one or more first publisher data records into one or more corresponding first recipient data records according to a master template, wherein the data being arranged in one or more of the first recipient data records in one or more first recipient fields according to a first recipient template, and wherein the master template includes one or more master fields for establishing a mapping between one or more first publisher fields of the first publisher data records and one or more first recipient fields of the first recipient data records.

8. The method according to claim 7, further comprising parsing all or a portion of the data from one or more first publisher records into one or more corresponding second recipient data records according to the master template, wherein data is arranged in one or more of the second recipient data records in one or more second recipient fields according to a second recipient template, and wherein one or more master fields establish a mapping between one or more first publisher fields of the first publisher data records and one or more second recipient fields of the second recipient data records.

9. The method according to claim 7, further comprising:
receiving extracted data from a second publisher database of a second publisher system to create one or more second publisher data records, wherein data in one or more second publisher data records is arranged in one or more second publisher fields according to a second publisher template, and wherein one or more second publisher fields correspond to one or more fields of the second publisher database; and
parsing all or a portion of the data from one or more second publisher data records into one or more corresponding first recipient data records according to the master template, the data being arranged in one or more of the first recipient data records in one or more first recipient fields according to the first recipient data template and wherein one or more of the master fields establish a mapping between one or more second publisher fields of the second publisher data records and one or more first recipient fields of the first recipient data records.

10. The method according to claim 9, further comprising parsing all or a portion of the data from one or more second publisher data records into one or more corresponding second recipient data records according to the master template, wherein the data being arranged in one or more of the second recipient data records in one or more second recipient fields according to the second recipient template, and wherein one or more of the master fields establishes a mapping between one or more second publisher fields of the second publisher records and one or more second recipient fields of the second recipient data records.

11. The method according to claim 7, further comprising forwarding one or more first recipient data records to a first recipient system for storing all or a portion of the data from one or more first recipient data records into a first recipient database.

12. The method according to claim 7, wherein the data is extracted from the first publisher database at a predetermined time.

13. The method according to claim 7, wherein one or more first recipient data records are forwarded to the first recipient system according to a predetermined protocol.

14. The method according to claim 7, wherein one or more first recipient data records include a second format different from a first format of the first publisher data records.

15. The method according to claim 7, wherein the first recipient template includes a related child template having child template fields corresponding to a nested data structure within the first recipient template.

16. A method for integrating data between computer systems comprising:
receiving a plurality of sets of one or more respective publisher data records each from a respective publisher system,
parsing all or a portion of the data in each set of publisher data records into one or more sets of respective recipient data records for a respective recipient system according to a master template, wherein:
the data contained in each respective set of publisher records is arranged according to a respective publisher template,
the data in each respective set of recipient records is arranged according to a respective recipient template, and
the master template includes one or more master fields for establishing a mapping between one or more of the respective publisher fields of one or more of the respective sets of publisher data records and one or more of the respective recipient fields of one or more respective sets of recipient data records.

17. A system for integrating data between computer systems comprising:
a processing computer system for receiving one or more first publisher data records, the one or more first publisher data records comprising data extracted from a first publisher database of a first publisher system and arranged in one or more first publisher fields according to a first publisher template, wherein one or more of the first publisher fields correspond to one or more fields of the first database;
a processor for processing the data in one or more of the first publisher data records by parsing all or a portion of the data in the one or more first publisher data records into one or more corresponding first recipient data records according to a master template, wherein the data being arranged in the one or more first recipient data records in one or more first recipient fields according to a first recipient template, and wherein the master template includes one or more master fields for establishing a mapping between one or more first publisher fields of the first publisher data records and one or more recipient fields of the first recipient data records.

18. The system according to claim 17, wherein the processing computer system receives the one or more first publisher data records from a first publisher system in communication with the processing computer system.

19. The system according to claim 17, wherein one or more first recipient data records are sent to a second system.

20. The system according to claim 17, wherein the first publisher system communicates with the processing computer system via a computer network.

21. The system according to claim 20, wherein the computer network is selected from the group consisting of: a wired network, a wireless network, a LAN, a WAN, and the Internet.

22. The system according to claim 17, wherein the processing computer system archives the first publisher data records and/or the first recipient data records.

23. The system according to claim 17, wherein the processing computer system encrypts the first recipient data records.

24. The system according to claim 17, wherein the processing of data for parsing is carried out in real time.

25. The system according to claim 19, wherein the first recipient records are sent to the first recipient system at a predetermined time.

26. The system according to claim 25, wherein the predetermined time is determined according to a recurring schedule.

27. The system according to claim 17, wherein the first recipient template includes a related child template for arranging nested data within the first recipient data records, and wherein the related child template includes one or more child template fields which correspond to one or more fields of the master template.

28. A system for integrating data between computer systems comprising:
a client application operating on a first publisher system for extracting data from a first publisher database and arranging the extracted data into one or more first publisher data records, wherein the data in the one or more publisher data records is arranged in one or more first publisher fields according to a first publisher template, and wherein one or more first publisher fields correspond to one or more fields of the first database; and
a processing computer in communication with the first publisher system, the processing computer receiving one or more first publisher data records and operating a processing application for:
parsing all or a portion of the data from one or more first publisher data records into one or more corresponding first recipient records using a master template, the data being arranged in one or more first recipient data records in one or more first recipient fields according to a first recipient data template, wherein the master template includes one or more master fields for establishing a mapping between one or more first publisher fields of the first publisher records and one or more first recipient fields of the first recipient data records,
wherein the processing computer forwards the first recipient data records to a first recipient system.

29. A method for integrating data over a computer network, the computer network allowing communication between a processing computer, a plurality of publisher systems and a plurality of recipient systems in communication with the processing computer, the method comprising:
receiving one or more sets of data extracted from a respective database of a respective publisher system to create one or more sets of one or more respective publisher data records, wherein:
the data in each set of one or more publisher data records is arranged in one or more publisher fields according to a respective publisher template of a particular publisher system, and
the one or more of the respective publisher fields correspond to one or more fields of the respective publisher database,
forwarding each set of publisher data records to the processing computer;
using the processing computer, parsing all or a portion of the data contained in each set of publisher data records into one or more corresponding sets of one or more recipient data records according to a master template, wherein:
each set of recipient data records is for a particular recipient system,
the data in each set of recipient data records being arranged in one or more respective recipient data fields according to a respective recipient template of a particular recipient system,
the master template includes one or more master fields for establishing a mapping between one or more respective publisher fields of one or more sets of publisher data records and one or more respective recipient fields of one or more sets of recipient data records, and
forwarding each respective set of recipient data records to a respective recipient system.

30. A system for integrating data between computer systems comprising:
a processing system for communicating with a plurality of publisher systems and for communicating with a plurality of recipient systems wherein:
each publisher system extracts one or more sets of data from a respective publisher database to create one or more sets of one or more publisher data records, wherein:
the data in each set of one or more publisher data records is arranged in one or more publisher fields according to a respective publisher template of a particular publisher system,
the one or more of the respective publisher fields correspond to one or more fields of the respective publisher database, and
each set of publisher data records are sent to the processing computer;
the processing computer parses all or a portion of each set of publisher data records into one or more corresponding sets of one or more recipient data records according to a master template, the data in each set of recipient data records being arranged in one or more respective recipient data fields according to a respective recipient template of a particular recipient system, and
the master template includes one or more master fields for establishing a mapping between one or more respective publisher data fields of one or more sets of respective publisher data records and one or more respective recipient fields of one or more sets of recipient data records.

31. A computer readable medium having computer instructions provided thereon for enabling a computer system to perform a method for integrating data between computer systems, the method comprising:
extracting data from a first publisher database of a first publisher system to create one or more first publisher data records, wherein data in the one or more first publisher data records is arranged in one or more first publisher fields according to a first publisher template, wherein one or more of the first publisher fields correspond to one or more fields of the first publisher database; and
parsing all or a portion of the data from the one or more first publisher data records into one or more corresponding first recipient data records according to a master template, wherein data is arranged in one or more of the first recipient data records in one or more of the first recipient fields according to a first recipient data template, and wherein the master template includes one or more master fields for establishing a mapping between one or more of the first publisher fields of the first publisher data records and one or more of the first recipient fields of the first recipient data records.

32. A computer application program operable on a computer system for enabling the computer system to perform a method for integrating data between computer systems, the method comprising:
extracting data from a first publisher database of a first publisher system to create one or more first publisher data records, wherein data in the one or more first publisher data records is arranged in one or more first publisher fields according to a first publisher template, wherein one or more of the first publisher fields correspond to one or more fields of the first publisher database; and
parsing all or a portion of the data from the one or more first publisher data records into one or more corresponding first recipient data records according to a master template, wherein data is arranged in one or more of the first recipient data records in one or more first recipient fields according to a first recipient data template, and wherein the master template includes one or more master fields for establishing a mapping between one or more first publisher fields of the first publisher data records and one or more first recipient fields of the first recipient data records.

33. A computer readable medium having computer instructions provided thereon for enabling a computer system to perform a method for integrating data between computer systems, the method comprising:
receiving one or more first publisher data records, the first publisher data records being received from a first publisher system and comprising data extracted from a first publisher database and arranged in the first publisher data records in one or more first publisher fields according to a first publisher template, wherein one or more first publisher fields correspond to one or more fields of the first publisher database; and
parsing all or a portion of the data from one or more first publisher data records into one or more corresponding first recipient data records according to a master template, wherein the data being arranged in one or more of the first recipient data records in one or more first recipient fields according to a first recipient template, and wherein the master template includes one or more master fields for establishing a mapping between one or more first publisher fields of the first publisher data records and one or more first recipient fields of the first recipient data records.

34. A computer application program operable on a computer system for enabling the computer system to perform a method for integrating data between computer systems, the method comprising:
receiving one or more first publisher data records, the first publisher data records being received from a first publisher system and comprising data extracted from a first publisher database and arranged in the first publisher data records in one or more first publisher fields according to a first publisher template, wherein one or more first publisher fields correspond to one or more fields of the first publisher database; and
parsing all or a portion of the data from one or more first publisher data records into one or more corresponding first recipient data records according to a master template, wherein the data being arranged in one or more of the first recipient data records in one or more first recipient fields according to a first recipient template, and wherein the master template includes one or more master fields for establishing a mapping between one or more first publisher fields of the first publisher data records and one or more first recipient fields of the first recipient data records.

35. A computer readable medium having computer instructions provided thereon for enabling a computer system to perform a method for integrating data between computer systems, the method comprising:
receiving a plurality of sets of one or more respective publisher data records each from a respective publisher system,
parsing all or a portion of the data in each set of publisher data records into one or more sets of respective recipient data records for a respective recipient system according to a master template, wherein:
the data contained in each respective set of publisher records is arranged according to a respective publisher template,
the data in each respective set of recipient records is arranged according to a respective recipient template, and
the master template includes one or more master fields for establishing a mapping between one or more respective publisher fields of one or more respective sets of publisher data records and one or more respective recipient fields of one or more respective sets of recipient data records.

36. A computer application program operable on a computer system for enabling the computer system to perform a method for integrating data between computer systems, the method comprising:
receiving a plurality of sets of one or more respective publisher data records each from a respective publisher system,
parsing all or a portion of the data in each set of publisher data records into one or more sets of respective recipient data records for a respective recipient system according to a master template, wherein:
the data contained in each respective set of publisher records is arranged according to a respective publisher template,
the data in each respective set of recipient records is arranged according to a respective recipient template, and
the master template includes one or more master fields for establishing a mapping between one or more respective publisher fields of one or more respective sets of publisher data records and one or more respective recipient fields of one or more respective sets of recipient data records.

37. A computer readable medium having computer instructions provided thereon for enabling a computer system to perform a method for integrating data over a computer network, the computer network allowing communication between a processing computer, a plurality of publisher systems and a plurality of recipient systems in communication with the processing computer, the method comprising:
extracting one or more sets of data from a respective database of a respective publisher system to create one or more sets of one or more respective publisher data records, wherein:
the data in each set of one or more publisher data records is arranged in one or more publisher fields according to a respective publisher template of a particular publisher system, and
the one or more of the respective publisher fields correspond to one or more fields of the respective publisher database,
forwarding each set of publisher data records to the processing computer;
using the processing computer, parsing all or a portion of the data contained in each set of publisher data records into one or more corresponding sets of one or more recipient data records according to a master template, wherein:
each set of recipient data records is for a particular recipient system,
the data in each set of recipient data records being arranged in one or more respective recipient data fields according to a respective recipient template of a particular recipient system,
the master template includes one or more master fields for establishing a mapping between one or more respective publisher fields of one or more sets of publisher data records and one or more respective recipient fields of one or more sets of recipient data records, and
forwarding each respective set of recipient data records to a respective recipient system.

38. A computer application program operable on a computer system for enabling the computer system to perform a method for integrating data over a computer network, the computer network allowing communication between a processing computer, a plurality of publisher systems and a plurality of recipient systems in communication with the processing computer, the method comprising:
extracting one or more sets of data from a respective database of a respective publisher system to create one or more sets of one or more respective publisher data records, wherein:
the data in each set of one or more publisher data records is arranged in one or more publisher fields according to a respective publisher template of a particular publisher system, and
the one or more of the respective publisher fields correspond to one or more fields of the respective publisher database,
forwarding each set of publisher data records to the processing computer;
using the processing computer, parsing all or a portion of the data contained in each set of publisher data records into one or more corresponding sets of one or more recipient data records according to a master template, wherein:
each set of recipient data records is for a particular recipient system,
the data in each set of recipient data records being arranged in one or more respective recipient data fields according to a respective recipient template of a particular recipient system,
the master template includes one or more master fields for establishing a mapping between one or more respective publisher fields of one or more sets of publisher data records and one or more respective recipient fields of one or more sets of recipient data records, and
forwarding each respective set of recipient data records to a respective recipient system.
